(19) United States
(12) Patent Application Publication
(10) Pub. No.: US 2010/0246902 A1
(43) Pub. Date: Sep. 30, 2010

(54) Method and apparatus to combine biometric sensing and other functionality

(75) Inventors: Robert K. Rowe, Albuquerque, NM (US); Philip Scarfo, Carlsbad, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lumidigm, Inc., Albuquerque, NM (US)

(21) Appl. No.: 12/660,243

(22) Filed: Feb. 22, 2010

Related U.S. Application Data
(60) Provisional application No. 61/155,651, filed on Feb. 26, 2009.

(51) Int. Cl. G06K 9/00

(52) U.S. Cl. 382/115

(57) ABSTRACT

A multispectral system is disclosed that can image a biometric features as well as secondary objects or environments. In some embodiments machine readable information and a biometric images can be imaged using a multispectral systems disclosed herein. Such systems can be used to implement a number of processes that can include secondary authentication, alternate authentication, two-factor authentication, one-time authentication, etc. Some embodiments of the invention provide for greater functionality in a fingerprint reader in order to variously increase security, increase user convenience, decrease system size, decrease system complexity, decrease system cost, increase system throughput or transaction speed, provide alternative authentication, record and/or confirm the identity of a person.

### CROSS-REFERENCES TO RELATED APPLICATIONS

This application is a non-provisional, and claims the benefit, of commonly assigned U.S. Provisional Application No. 61/155,651, filed Feb. 26, 2009, entitled “Method and Apparatus To Combine Biometric Sensing and Other Functionality,” the entirety of which is herein incorporated by reference for all purposes.

### BACKGROUND

Fingerprint sensors typically require contact between the skin and sensor in order to capture an image. Such fingerprint sensors use various means to acquire an image of the fingerprint including capacitive, RF, thermal, ultrasound, mechanical, and optical methods. Optical sensors used for acquiring fingerprint images typically comprise an imager, one or more illumination sources, a platen, optical components such as lenses and mirrors, and other parts. It can be common to arrange the imaging system such that the angle of the imaging axis with respect to the platen at the interface where the finger touches the sensor is greater than the critical angle. This arrangement ensures that the finger-platen interface appears reflective to the imager when no finger is present, due to total internal reflectance (TIR) effects at the platen-air boundary. In such cases, the imager is able to detect an object only when a portion of the object with a sufficiently high index of refraction comes in optical contact with the platen surface. At these points of contact, the TIR sensor is able to detect a relative change in the reflected illumination light intensity, which can be a relative darkness or brightness depending on the specific arrangement of the illumination and imaging optics. This spatially varying change in the reflected light intensity is the basis for forming a fingerprint image. Under such conditions, the TIR sensor is unable to effectively capture images from most other objects that are placed near the sensor. As such, a TIR fingerprint sensor and most other types of fingerprint sensors cannot be used to acquire images from non-fingerprint objects such as barcodes, documents, machine readable characters and the like.

### BRIEF SUMMARY

Embodiments of the present invention provide various functionality for multispectral imaging beyond biometric functions. Embodiments can include using a multispectral system to both collect biometric data as well as collect other images. These other images can include images of the ambient environment, machine readable data, bar codes, multispectral materials, etc. Moreover, in some embodiments, techniques are provided for two factor authentication, temporary authentication, onetime authentication, authentication for enrollment, limited time authentication, alternative authentication, etc.

In some embodiments, systems and methods are disclosed that includes an illumination source, an imaging system, and a controller. The controller can be interfaced with the illumination source and the imaging system; and can include various instructions. The controller can include instructions to illuminate a purported skin site of an individual using the illumination source. Instructions can be included that derive an image of the purported skin site from light received by the imaging system after scattering from the purported skin site. The controller can also include instructions to illuminate an object different from a skin site using the illumination source, and derive an image of the object from light received by the imaging system after scattering from the object. The object can include machine readable data with or without multispectral material.

In some embodiments, systems and methods are disclosed that includes an illumination source, an imaging system, and a controller. The controller can be interfaced with the illumination source and the imaging system; and can include various instructions. These instructions can cause the system to illuminate an object comprising machine readable data under a plurality of distinct optical conditions during a single illumination session. Instructions can also derive a multispectral image of the machine readable data from light after scattering from the machine readable data for each of multiple of the plurality of distinct optical conditions.

Some embodiments can include a method that illuminates machine readable data under a plurality of distinct optical conditions; receives light scattered from the machine readable data separately for each of the plurality of distinct optical conditions; and determines whether the machine readable data is fraudulent. The machine readable data can include a barcode and/or optically variable material or features. Moreover, the same imager can be used to receive light scattered from a skin site. A biometric function can then be performed with the image of the skin site.

In some embodiments, a multispectral barcode is provided. A multispectral barcode can include a substrate, a barcode disposed on the substrate, and a multispectral feature disposed on the substrate. The substrate can include a key fob, a plastic card, a business, card, a document, a license, a passport, a ticket, a business card, an id badge, etc. In some embodiments, a multispectral barcode can be replaced with any type of machine readable data. Moreover, the multispectral feature can include a feature printed with color changing dyes, a hologram, etc.

In some embodiments, two factor authentication techniques are provided. In some embodiments, a method can be used where a first object is illuminated at a target site with an illumination source. A first image of the first object can be derived from light received by an imaging system after scattering from the object. A second object can be illuminated. A second image of the second object can be derived using the same illumination system. An authentication function that uses the first image and the second image can be used for authentication purpose. In some embodiments, data can be extracted from the first object and it can be determined whether the extracted data corresponds with features of the second image. For example, a biometric template can be extracted from the first data and it can be compared with biometric data from the second image. In other embodiments, the extracted data can include a pointer to a memory location that includes data for comparison, such as a biometric template.

In some embodiments, a system is disclosed that includes an illumination source; an imaging system; and a controller interfaced with the illumination source and the imaging system. The controller can include instructions to illuminate an object with machine readable data at a target site with the illumination source, wherein the object includes machine readable data. Instructions can also be included that derive an image of the machine readable data from light received by the imaging system after scattering from the purported skin site. The controller can include instructions to extract a message from the image of the machine readable data; and instructions to alter the operational mode of the system in response to the message extracted from the image.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows a side view of a multispectral imaging system that can be used in any of the embodiments of the invention.

FIG. 2 shows a flowchart of a process for imaging both the ambient environment and a biometric according to some embodiments of the invention.

FIG. 3 shows a flowchart of another process for imaging both the ambient environment and a biometric according to some embodiments of the invention.

FIG. 4 shows a flowchart of a process where a triggering event causes ambient image or video collection according to some embodiments.

FIG. 5A shows a two dimensional barcode printed on multispectral material according to some embodiments of the invention.

FIG. 5B shows a photocopy of the two dimensional barcode in FIG. 5A.

FIG. 6 shows a photograph of some holographic security labels with barcodes printed using opaque thermal transfer resin, according to some embodiments of the invention.

FIGS. 7A, 7B, 7C, and 7D each show an example of a key fob with a barcode and multispectral material according to some embodiments of the invention.

FIG. 8 shows a flowchart of a process for use with a primary and secondary authentication system according to some embodiments of the invention.

FIG. 9 shows a flowchart of a process for imaging a barcode that can include biometric information as well as user presets.

FIG. 10A shows a typical identification card.

FIG. 10B shows an identification card with printed multispectral features according to some embodiments of the invention.

FIG. 10C shows an identification card with a white light hologram according to some embodiments of the invention.

FIG. 11 shows a portion of both a genuine and a copy of a United States twenty dollar bill that includes color changing inks.

FIG. 12 shows a flowchart of one method for showing differences between a genuine and a counterfeit document implementing multispectral material or features according to some embodiments of the invention.

FIG. 13A shows a recombined luminance image from the three genuine images shown in FIG. 11, and FIG. 13B shows a recombined luminance image from the three copied images shown in FIG. 11.

FIG. 13C shows the hue and saturation values from the genuine image shown in FIG. 13A and FIG. 13D shows the hue and saturation values for the copied image in FIG. 13B

FIG. 14 shows images of a white light hologram and a copy of the white light hologram acquired by a multispectral system using white light at three different illumination angles and captured by a color camera.

FIG. 15A shows a recombined luminance image from the three genuine images shown in FIG. 14, and FIG. 15B shows a recombined luminance image from the three copied images shown in FIG. 14.

FIG. 15C shows the hue and saturation values for the genuine image in FIG. 15A, and FIG. 15D shows the hue and saturation values for the copied image in FIG. 15B.

FIG. 16 shows a whole hand sensor according to some embodiments of the invention.

FIGS. 17A, 17B, and 17C show images of a passport produced with non-polarized illumination at different illumination angles, and FIGS. 18A, 18B and 18C show images of a copy of the same passport produced with non-polarized illumination at different illumination angles.

FIG. 19A shows pseudo color images created from FIGS. 17A, 17B, 17C, and 17D, and FIG. 19B shows pseudo color images created from FIGS. 18A, 18B, 18C, and 18D.

FIG. 20 shows a process for reading and authenticating machine readable documents along with biometric data.

FIG. 21 shows a mobile phone with an image of a barcode presented thereon according to some embodiments of the invention.

FIG. 22 shows an example of a time limited authentication process according to some embodiments of the invention.

FIG. 23 shows a flowchart of a process for allowing one-time access according to some embodiments of the invention.

FIG. 24 shows another embodiment providing one-time access according to some embodiments of the invention.

FIG. 25 shows a flowchart of a process for authenticating a user with a two factor authentication using a multispectral system according to some embodiments of the invention.

FIG. 26 shows a block diagram of a biometric sensor system including a computational device and peripheral devices according to one embodiment.

FIG. 27A shows a multispectral barcode with positive multispectral elements according to some embodiments of the invention.

FIG. 27B shows a multispectral barcode with negative multispectral elements according to some embodiments of the invention.

FIG. 28 shows a screen shot of imaging software showing a multispectral bar code imaged with a single illumination system.

FIG. 29 shows four different images collected by a multispectral imager and were illuminated under different illumination conditions.

FIG. 30 shows a screen shot of imaging software showing an image produced by the application of a pixel-wise minimum applied to the four planes of multispectral data shown in FIG. 29.

FIG. 31 shows four multispectral data planes of a negative barcode that are analogous to the positive barcode of FIG. 29 according to some embodiments of the invention.

FIG. 32 shows a screen shot of imaging software showing an image of a composite barcode created using the pixel-minimum operation according to some embodiments of the invention.

### DETAILED DESCRIPTION

Embodiments disclosed herein provide for greater functionality in a fingerprint reader in order to variously increase security, increase user convenience, decrease system size, decrease system complexity, decrease system cost, increase system throughput or transaction speed, provide alternative authentication, record and/or confirm the identity of a person from whom a measurement of alcohol concentration is made, or provide for other such advantages.

The terms “multispectral sensor” and “multispectral system” are used herein to mean an optical system that is configured to collect multiple, different images of a finger, palm, hand or other object during a single session. A multispectral system can include a multispectral sensor, which acquires biometric data and secondary data, and a computer with instructions to process the biometric data and/or secondary data in some way. resolutions, or any combination of the aforementioned. Imaging under a plurality of distinct optical conditions during a single illumination session is referred to herein as “multispectral imaging”. The set of all images collected under a plurality of distinct optical conditions during a single illumination session is referred to herein as “multispectral data” or “multispectral images”. The different optical conditions can include different illumination wavelengths, different polarization conditions, different illumination angles, different imaging angles, different focal distances, different imaging resolutions, or any combination of the aforementioned. In some optical conditions, the resulting images are significantly affected by the presence and distribution of TIR phenomena at the interface between the sample and the platen. These images are referred to herein as “TIR images.” In some optical conditions, the resulting images are substantially unaffected by the presence or absence of TIR effects at the platen. These images are referred to herein as “direct images”.

The term “finger print sensor” is being used in this disclosure to represent all biometric sensors that acquire images and other data associated with the dermatoglyphic patterns and other patterns on the skin. Such biometric sensors include but are not limited to single-finger fingerprint sensors, multi-finger (e.g., 2- or 4-finger) fingerprint sensors, palm sensors, and/or whole-hand sensors. Similarly, the term “finger” is used to represent all possible skin sites including finger pad, The term “dermatoglyphic image” is used herein to describe images of skin. A dermatoglyphic image can include a fingerprint image a hand print image, an image of multiple fingerprint, a thumbprint image, a footprint image, etc. Moreover, while various embodiments are described with reference to finger images and/or fingerprints, any other type of skin based physical characteristic can be substituted.

The term “multispectral material” is any material that provides a response that varies with changes in any of the following: illumination angle, illumination wavelength(s), imaging angle, imaging wavelength(s), polarization, etc. Similarly, the term “multispectral feature” is any feature that provides a response that varies with a change in any of the following: illumination angle, illumination wavelength(s), imaging angle, imaging wavelength(s), polarization, etc. Images of multispectral materials or multispectral features differ when illuminated under different multispectral conditions. Ex'amples of multispectral material or multispectral features can include holograms, color-changing inks or paints, optically variable inks or paints, polarization sensitive paints, inks and other material, spectral and/or textural characteristics of the substrate or a laminated cover, and other such features. Holograms and optically variable ink can be particularly sensitive to angles of illumination and/or imaging, though other aspects of multispectral conditions can give rise to significant signals that are also used in the present invention While reference may be made to a specific multispectral material and/or multispectral feature in this disclosure, any multispectral material and/or multispectral feature may be substituted and used. The term “multispectral material” can also be described as an “optically variable material,” and the term “multispectral feature” can also be termed an “optically variable feature.” Thus, “optically variable” can describe the condition of providing an optically different response depending on the illumination and/or imaging conditions. The term “multispectral content” refers generally to any of “multispectral material”, “optically variable material,” and/or “multispectral feature”.

“Machine readable data” is a term used herein to indicate an image of some kind that can be acquired by a multispectral sensor and/or contains elements that can be interpreted by the multispectral system in a meaningful and deterministic way. Images containing machine readable data are generally capable of producing substantially the same extracted data (e.g. message, command, bit sequence, etc) from instance to instance after appropriate processing is applied to the image. If the image is too corrupted to extract the information incorporated in the machine readable data (due to noise, dim lighting, non-uniform light, glare, distortions, etc) an error is generally reported. In contrast, images that do not contain machine readable data may be processed and interpreted in various ways, but the information so extracted is generally tested for similarity to a reference and exactness isn't expected. For example, a biometric image of some kind may have biometric features extracted from it but those features are typically compared to a compatible reference set of features to determine degree of statistical similarity rather than a binary assessment of match/no-match.

Examples of machine readable data can include a 1D or 2D binary barcode, a 1D or 2D color barcode, machine readable text, ordinary text to which optical character recognition (OCR) may be applied, holographic barcodes, barcodes fabricated with color changing ink, barcodes fabricated with polarization sensitive material, or other forms. The term “barcode” is used throughout the disclosure as one example of machine readable data, but the term is not meant to be limiting and any other type of machine readable data may be used equivalently. Indeed, while many embodiments are described in conjunction with a barcode, any type of machine readable data can be substituted.

Barcodes can contain information describing an image (such as a fingerprint image) or the biometric characteristics of, for example, a fingerprint (such as locations, direction and/or types of minutiae in the fingerprint). Such characteristics may be combined in a single data structure, which is referred to as a “biometric template” or just “template”. Barcodes can contain information such as creation dates or timestamps, valid-until dates, encryption keys, pointers to entries in certain databases, account information such as transaction amounts and account balances, digital signatures, sensor commands, and other such information. In some embodiments, barcode information can be encrypted using a variety of symmetric and asymmetric techniques and algorithms as known in the art. In some embodiments, an image of the barcodes may be acquired by the multispectral system using a plurality of imaging conditions. In other embodiments, an image of the barcodes may be acquired by the multispectral system using a single imaging condition.

A multispectral system may be used for fingerprint imaging. Fingerprint images can be acquired either when the finger is in contact with the sensor or not in contact with the sensor but within the field of view of the multispectral sensor. When the multispectral system is not being used to acquire and process fingerprint biometric information (or in some cases in conjunction with such acquisition), the multispectral system may be configured to conduct a second function. Some examples of a second function can include acquisition of image/video for surveillance, wake-up, audit, and/or log-out; acquisition of secondary or alternative biometrics; acquisition of secondary or alternative authorization; acquisition of biometric credentials for subsequent authentication; acquisition of instrumentation mode settings; acquisition of ambient lighting conditions; etc.

Most conventional fingerprint sensors use some form of imaging technology that requires contact between the finger and the sensor to produce an image. Common fingerprint imaging technologies include capacitive, radio-frequency, thermal, ultrasound and optical sensors based on total internal reflectance (TIR) imaging. In all such cases, when a suitable sample (e.g. a fingertip) isn't touching the sensor, the sensor is unable to acquire images of nearby objects. In many cases, even if an object other than a finger is in contact with a conventional fingerprint sensor, the sensor is still unable to acquire images of the object since certain important object characteristics are different than what the sensor is designed to acquire (e.g. different impedance in an RF sensor, different index of refraction in a TIR imaging sensor, etc). In contrast, a multispectral fingerprint sensor can be an optical sensor that is designed such the angle between the imaging axis (or axes) and the platen-finger interface is less than the optical critical angle for some or all of the images acquired. In this way, substantially no TIR effects are present in the imaging system and the imager can see objects that are not in contact with the sensor but still within the field of view and in a plane with suitable degree of focus (or the focus may be adjusted according to the position of the object).

### Multispectral System

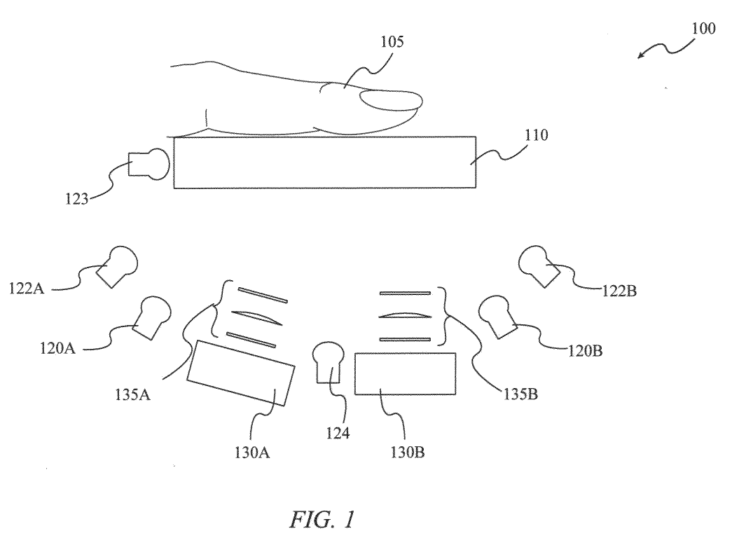

FIG. 1 shows a side view of an example of a multispectral system. Such an imaging system can be used to acquire multispectral images. Multispectral system 100 shown in FIG. 1 includes two imagers 130. While two imagers are shown, a single imager may be used or more than two imagers may be used. Imagers 130 can include any type of imaging device with spatial resolution, such as a camera, an active pixel imager, a CMOS imager, an imager that images in multiple wavelengths, a CCD camera, a photo detector array, TFT imager, etc. In some embodiments, imagers 130A and 130B may be spatially separated. In some embodiments imagers 130A and 130B may view substantially the same portion of the finger 105 by means of beamsplitters and other such means known in the art. In other embodiments, the imagers can be combined on a single circuit board, for example, as conjoined wafer-level cameras. In some embodiments, imagers 130 can be positioned to image with different imaging angles as shown. Multiple imagers can be used with different imaging angles and different imaging positions. In some embodiments, the first imager 130A may receive light from a first portion of the finger 105 placed on the platen 110 at a target site. The second imager 130B may receive light from a second portion of the finger 105. The first portion and the second portion may overlap or be completely distinct.

Each imager may also include various optical elements 135. While three optical elements 135 are shown for each imager, any number including zero may be used. These optical elements can include lenses, filters, Bayer filters, CYMG filter, RGBE filter, polarizers, etc. A single or multiple illumination sources can be used. In FIG. 1, five illumination sources 120, 122, 123, and 124 are shown. Illumination source 124 illuminates platen 110 at an angle normal with the platen. Illumination sources 120 and 122 can be used to illuminate platen at various other angles including angles greater than, less than, or equal to the critical angle. In some embodiments, one or more illumination sources can be positioned to illuminate the platen through a side of the platen as shown in by illumination source 123. In this embodiment, illumination sources can be LEDs, laser diodes, incandescent sources, etc. or any combination thereof. In particular, the illumination sources can direct light toward target site at or on the platen. Or in touchless embodiments, at a target site may exist in some plane in free space.

Platen 110 can be constructed of a glass, plastic, or other material that is fully or partially transparent under the optical conditions used in multispectral system 100. Platen 110 can be a flat sheet or multi-dimensional structure with multiple facets and/or faces at various angles. Platen 110 can also be constructed to accommodate a single finger, multiple fingers, an entire hand, or other physical characteristics. In some embodiments, platen 110 can be removed and multispectral system 100 can be a contactless imaging system.

Acquisition of Image/Video for Surveillance, Wake-Up, Audit, and/or Log-Out

In some embodiments, a multispectral system can be used to collect and store images of the local environment acquired at some point before or after a fingerprint is acquired. For example, a multispectral system may be installed at a sensitive biometrically-controlled access point that can serve to authorize pharmaceutical dispensing within a hospital, or can serve to authorize physical entry into a secure facility, or can serve to authorize access to a terminal that authorizes high-value monetary transactions within or between financial institutions. In some embodiments, the multispectral sensor can acquire snapshots or video data for some period of time prior to and/or after biometric authorization and store or transmit these images in some form. At a later point in time, such image data can be retrieved and reviewed to further confirm identity and/or actions of people present proximal to the time that the biometric transaction was conducted. Multispectral sensors used for such purposes can have optical components such as optical zoom mechanisms, scanning mechanisms, mirrors and other such elements to enable such additional imaging functionality.

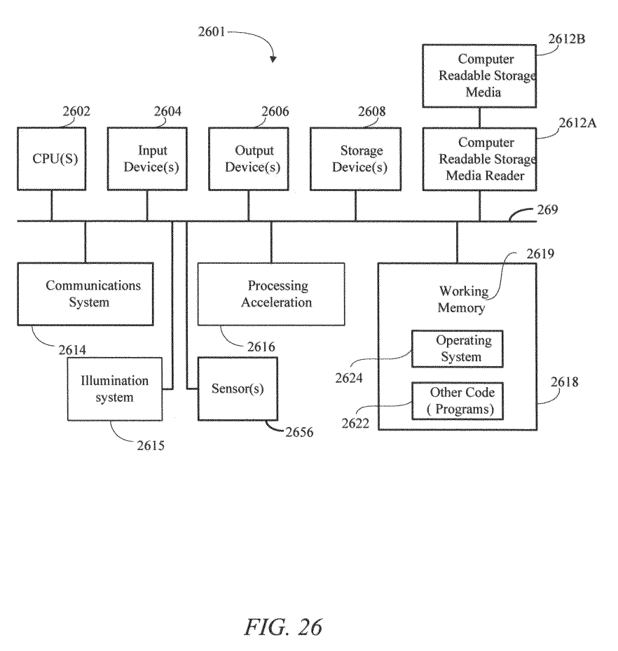

Alternatively, the acquisition of image or video data may occur at some pre-specified time interval when the sensor is not being used to acquire biometric data. As such, the multispectral sensor can act as a surveillance device capable of recording information about the local scene. Such image information can be processed by a computer processor (e.g., the computation device shown in FIG. 26) in some way to analyze the contents of the scene. The image information may be processed by the computer to compress the image or video data in some way prior to storage or transmittal to a remote location.

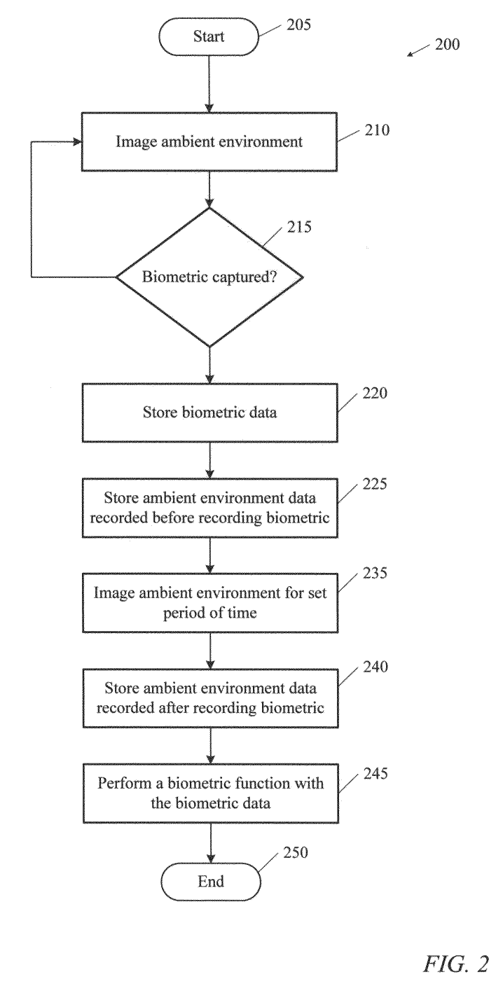

FIG. 2 shows a flowchart of process 200 for imaging both the ambient environment and a biometric according to some embodiments of the invention. Process 200 starts at block 205. At block 210 the ambient environment is imaged. The ambient environment, for example, can be imaged using any or all of a number of imagers of a multispectral system. In some embodiments, the ambient environment can be imaged for a set period of time at block 210. In other embodiments, the ambient environment can be imaged in a loop. In such an embodiment, initial images can be recorded and stored for a set period of time. Once the set period of time has been reached, any new images that are recorded replace the oldest images. The images can be imaged and/or recorded in real time. In some embodiments, the images can be stored as video images or as separate images.

At block 215 if a biometric is captured, process 200 can move on to block 220, or else process 200 returns to block 210. For example, the biometric can include a fingerprint, iris print, hand print, etc. The biometric can be recorded using any combination of multispectral illumination and/or imaging techniques. At block 220 the biometric data can be stored in memory. In some embodiments, the biometric data can be stored as one or more multispectral images. In other embodiments, the biometric data can be stored as minutiae locations, directions, and/or types or any other type of mathematical formulation representing the recorded fingerprint. At block 225 the ambient environment recorded prior to the fingerprint being captured is stored in long-term memory. In some embodiments, this can include copying the image or images from a short term memory location to a long term memory location. In some embodiments, the ambient environment images can also be linked or classified to indicate an association with the fingerprint. In some embodiments, time and/or location stamps can be included with the ambient environment images. At block 235, the ambient environment can again be imaged for a set period of time and the images stored at block 240. At block 245 a function is performed with the biometric data. This function can include, for example, identification of the user, validation of the user, and/or authentication of the user. At block 250 process 200 can end. In some embodiments, rather than ending, process 200 can return to block 210.

In some embodiments, various blocks shown in process 200 can be removed or rearranged. For instance, in some embodiments, only the ambient environment prior to collecting the biometric may be saved. Also, various amounts of ambient environment images can be stored. For example, the ambient environment can be imaged for one, five, or ten or more minutes before and/or after the biometric is captured. The corresponding images can be stored in long term memory. In other embodiments, more or fewer minutes of ambient environment images can be stored in memory.

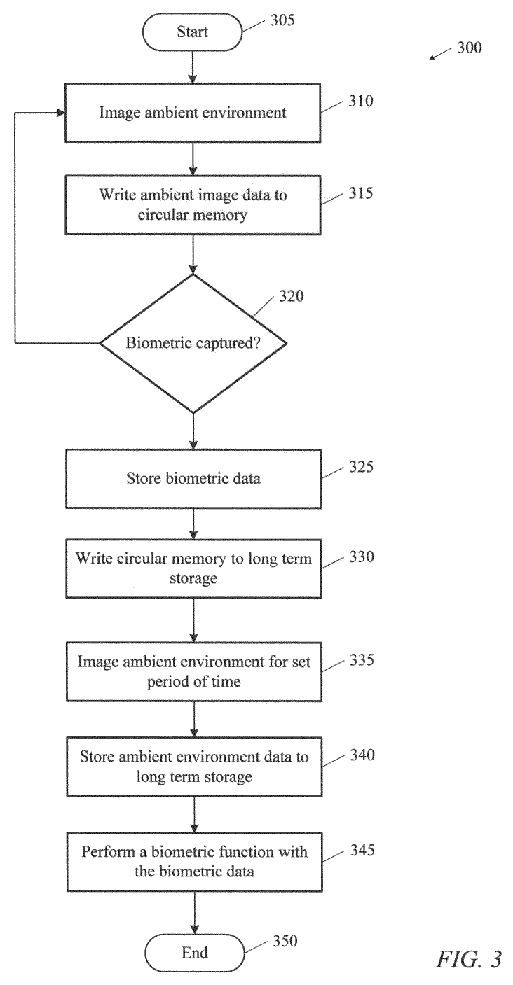

FIG. 3 shows a flowchart of another process 300 for imaging both the ambient environment and a biometric according to some embodiments of the invention. Process 300 starts at block 305. At block 310 the ambient environment is imaged and the resulting images and/or videos are stored to circular memory. Circular memory can allow storage for a set period of time, for a set number of images, for a set number of video frames, or for a set amount of memory. When the circular memory is full or the end of the memory has been reached, then new data is stored in place of the oldest data. At block 320 if a biometric image is captured, process 300 can proceed to block 325 and the biometric images can be stored. At block 330 the circular data is written and/or copied to long term memory. At block 335 the ambient environment can again be imaged for a set period of time and then stored in long term storage at block 340. In other embodiments, the ambient environment can be captured and the images stored until the circular memory is filled with images captured after the biometric was captured. At block 345 a biometric function can be performed; at block 350 process 300 can end. In some embodiments, rather than ending, process 300 can return to block 310. In some embodiments, various blocks shown in process 300 may be removed or rearranged and other steps inserted.

In another embodiment, the acquisition of image(s) or video data by the multispectral system may be triggered by some event. For example, a multispectral system mounted in the interior of a transportation vehicle (e.g., car, truck, boat, plane, train, farm or construction vehicle, etc.) can trigger the recording of information when an external door handle is activated. Alternatively, the multispectral system can begin recording image or video data when an impact or other extreme maneuver of the transportation vehicle is detected. In some cases, the multispectral system can collect image information and write such information to a circular buffer of some size in a continuous manner. In such a case, when a triggering event occurs, the contents of the circular buffer can be stored in long term memory or transmitted, providing a means to record information from a period of time prior to a triggering event. Additional image data may also be recorded during the triggering event as well as for some period of time afterward.

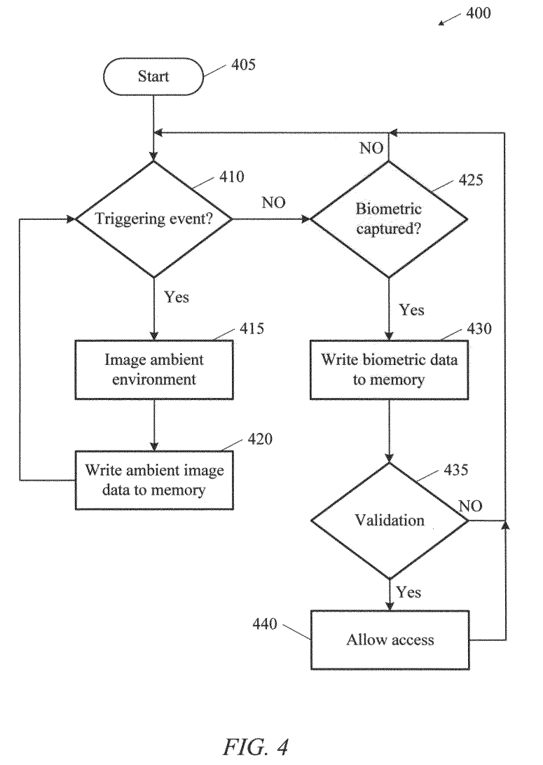

FIG. 4 shows a flowchart of process 400 where a triggering event causes ambient image or video collection according to some embodiments. Process 400 can be used in conjunction with a multispectral system. Process 400 starts at block 405. At block 410 process 400 can determine whether a triggering event has occurred. A triggering event can include any number of inputs. Examples of such inputs can include: detecting motion near the multispectral system, input from an automobiles' impact sensor(s), (e.g., the sensors that trigger airbags), input from accelerometer(s), input from a user interface, etc. Various other triggers can be used. What is important is that the triggering event triggers the system to image the ambient environment as shown at block 415. At block 420, the received data can be stored in long term memory. In some embodiments, the ambient environment can be continuously imaged and the data saved in circular memory. In such embodiments, the stored image data can be copied or transferred from the circular memory to a long-term storage device at block 420. Process 400 can continue by returning to block 410.

If the triggering event has not occurred as determined at block 410, process 400 continues to block 425. At block 425, if a biometric is captured, then process 400 continues to block 430, otherwise process 400 returns to block 410. In some embodiments, a delay or timeout can occur prior to returning to block 410. At block 430 biometric data can be processed and/or written to memory. Following block 430 some type of decision or function can be implemented based on the biometric. For example, at block 435 process 400 can determine if the biometric is sufficient to validate the user. If validation does not occur then process 400 returns to block 410. If validation does occur, the access is allowed at block 440 and process 400 returns to block 410.

In another embodiment, a multispectral system may record and/or process video data to provide motion detection. When motion is detected, the multispectral system may provide a “wake up” signal that may be used by the multispectral system as well as for other subsystems and services. For example, a multispectral system mounted by the entry into a building might cause nearby lights, illuminated signs, indicators and the like to turn on when motion is detected. The multispectral system might be used to detect such motion using one or more illuminators which may be visible or infrared LEDs. Alternatively, the multispectral system may use ambient light for such motion detection in cases where ambient light is sufficient for such functionality.

In another embodiment, a multispectral system can be used to monitor the local area after a proper authentication. In such cases, the multispectral system may acquire and analyze a video stream or series of images acquired periodically to determine when the user has left the immediate vicinity of the sensor, which may be used to provide authorization to use a device such as a computer, a shared workstation, a terminal, an ATM, a control console, or other such devices. At the point in time when the user leaves the immediate vicinity of the multispectral sensor, the multispectral system may trigger a log-off event or other such signal that might, for example, cause data displayed on a monitor to be erased, over-written, or otherwise obscured. Similarly, such event might log the user out of the associated computer system, workstation, terminal services, or console and may then require a re-authentication in order for a user to access any system services.

### Acquisition of Secondary or Alternative Biometrics

In some embodiments, the multispectral sensor may be used to acquire biometric information other than information from the fingerprint (handprint, palmprint, etc). For example, the multispectral system can acquire biometric information from the iris, the face, and/or from the shape of the fingers or hand. One or more of these biometric modes may be used to identify or confirm identity of the person using the multispectral system. Such biometric matching may be combined with the fingerprint biometric in some way to enable the multispectral system to operate as a multi-biometric system, or such biometrics may be used as an alternative to the fingerprint biometric. Moreover, various embodiments of the invention are described by referencing fingerprint biometrics, though other biometrics can be substituted for fingerprint biometrics.

### Acquisition of Secondary or Alternative Authorization

In cases where a fingerprint image from an authorized user isn't available or otherwise doesn't match any fingerprint previously recorded, the user may provide to the multispectral system a barcode(s) that can be used as an alternative means to gain access to a system or service. For example an authorization message could be contained within some barcodes acquired by the multispectral sensor. In some embodiments, some or all of the information contained in the barcodes may be encrypted and can require decryption by the multispectral system prior to the granting of authorization. In some embodiments the encryption/decryption method may be specific to a particular multispectral sensor and/or subset of multispectral sensors, such that only the particular multispectral sensor and/or the subset of multispectral sensors can decrypt the information in the barcode.

In some embodiments, the barcode may contain data that specifies a certain period of time (or can be used to specify such period of time) for which the authorization can be valid. Authorization can be granted if the time is less than a certain absolute date or a certain period of time has elapsed since the first use of the alternative authorization. In another embodiment, a particular alternative authorization message can be used a specified number of times before becoming invalid. In some embodiments, an alternative authorization may only be used for a single authorization, after which it becomes invalid. One means to accomplish a single-use authorization is to include a number as part of the barcode message. The sensor may check to see if the number encoded in the barcode message matches the next authorized number stored by the sensor. If so, the authorized number contained in the sensor may be updated by, for example, incrementing a counter. In so doing, the current barcode will no longer provide a valid means of authorization. A valid means would be required to contain the new current authorization value matching that stored in the sensor.

In some embodiments, an arbitrary image; drawing, barcode, photograph or other object may be used as an alternative to an authorized fingerprint. In this way, such arbitrary object may be enrolled or otherwise designated as an alternative means of authorization. In some embodiments, the same arbitrary object may then be presented at a later date and matched to the previously enrolled image of the arbitrary object to gain alternative authorization. In some embodiments, the statistical characteristics of the arbitrary object may be determined and recorded. In such cases, later acquisition of a similar arbitrary object by the multispectral system may be performed and authorization granted if the statistical characteristics of the two objects are sufficiently similar. Texture matching algorithms and other means known in the art may be used to determine the degree of statistical similarity image data to an enrolled image an

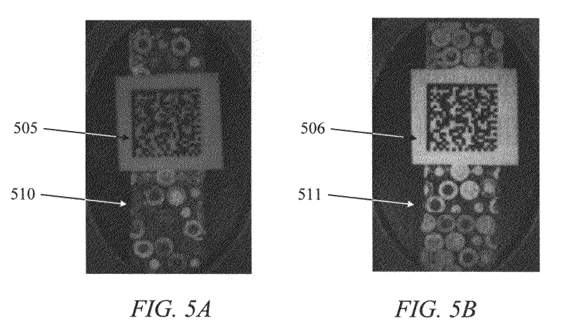

In some embodiments, the barcodes can be produced such that photocopies or scans of the barcodes will not provide the proper data. In some embodiments, barcodes can include multispectral material or features. FIG. 5A shows a two dimensional barcode 505 attached to multispectral material 510. In this case, the multispectral material is a white-light holographic material that provides different images based on the illumination angle, image angle, and illumination wavelength. The barcode 505 and holographic material 510 have been imaged by a multispectral system 100 comprised of a single color imager 130B and three different white-light LED sources 120A, 120B, and 122A. The three light sources were located at distinctly different azimuth angles relative the imaging axis. Three image frames were acquired with each of the thee light sources illuminated for one of the images. Because of the holographic nature of multispectral material 510, different portions of the material reflected different amounts and colors of light depending on the orientation of the illuminated light source. FIG. 5A is one simple representation of the difference of the images acquired under the multiple illumination conditions. In this case, the RGB images from each of the three images in the multispectral data were converted to Y—Cb—Cr. Each of the three luminance (Y) image planes were then combined and displayed as a single RGB image 510.

In contrast, FIG. 5B shows the results of collecting multispectral data from a high-quality color copy of the barcode and multispectral material used in FIG. 5A. The same multispectral sensor was used to produce multispectral data, which was then processed to extract the luminance and display the images in an identical manner as done to produce FIG. 5A. As can be seen by comparing FIG. 5A and FIG. 5B, the pseudo-color representation of the real multispectral material 510 and the representation of the color copy of multispectral material 511. The difference between the two materials is dramatic under multispectral imaging conditions, even though the difference between the original multispectral material and the color copy of it isn't nearly as obvious. Critically, the image of the barcode 505 or its copy 510 is virtually indistinguishable under both multispectral and conventional imaging and both barcodes produce images that are able to be processed by methods known in the art to extract the same message. Therefore, the use of multispectral material combined with multispectral imaging can be used as a means to detect original barcodes and distinguish them from copies.

The differences shown between FIG. 5A and FIG. 5B are large and readily observable to a human. The large magnitude of difference between genuine multispectral materials and copies (and therefore between genuine and copied barcodes) can also be detected automatically by multiple means. For example, some pseudo code to generate an indicator (VCode) of whether the multispectral data (RawImg) contains multispectral features is given below. Note that this code assumes that the input is unsigned raw (Bayer) image data passed in a 3D image stack.

```
function VCode=VCheck(RawImg);
% Check for validity of substrate by looking for color changes as a
% function of illumination angle/polarization
% Input images are expected to be a stack of raw Bayer images taken
% under multiple direct-illumination states
% VCode returns true if the media is valid, false otherwise
%
% Note -- this version just looks for a general color change as a function
of illumination across a significant number of pixels.
ColorPattern=‘bggr’; % Used for demosaic
NVPix=1000; % Minimum number of pixels that must show the
% expected properties in order for validity to be
% established
VThresh=0.2; % max possible variation = 1.0, none = 0.0
% generate demosaiced color images represented in YCbCr space so
% colors can be checked independently of illumination intensity
Img=zeros(n1,n2,3,n3);
for iplane=1:n3
  thisImg=demosaic(RawImg(:,:,iplane),ColorPattern);
  thisImg=mat2gray(thisImg);
  Img(:,:,:,iplane)=rgb2ycbcr(thisImg);
end;
% Produce a map of maximum chromaticity change per pixel, first in
% terms of the chromaticity components, Cb and Cr, then combined
delCb=max(Img(:,:,2,:),[ ],4)-min(Img(:,:,2,:),[ ],4);
delCr=max(Img(:,:,3,:),[ ],4)-min(Img(:,:,3,:),[ ],4);
delC=max(cat(3,delCb,delCr),[ ],3);
% Perform overall assessment -- this is simple pixel counting above a
% threshold within the image region.
idx=find(delC>VThresh);
if length(idx)>NVPix
  VCode=true;
else
  VCode=false;
end;
```

There are many other equally applicable methods that can be used to determine the presence or absence of multispectral features within a set of multispectral data and this code or this method is not intended to be limiting in any way.

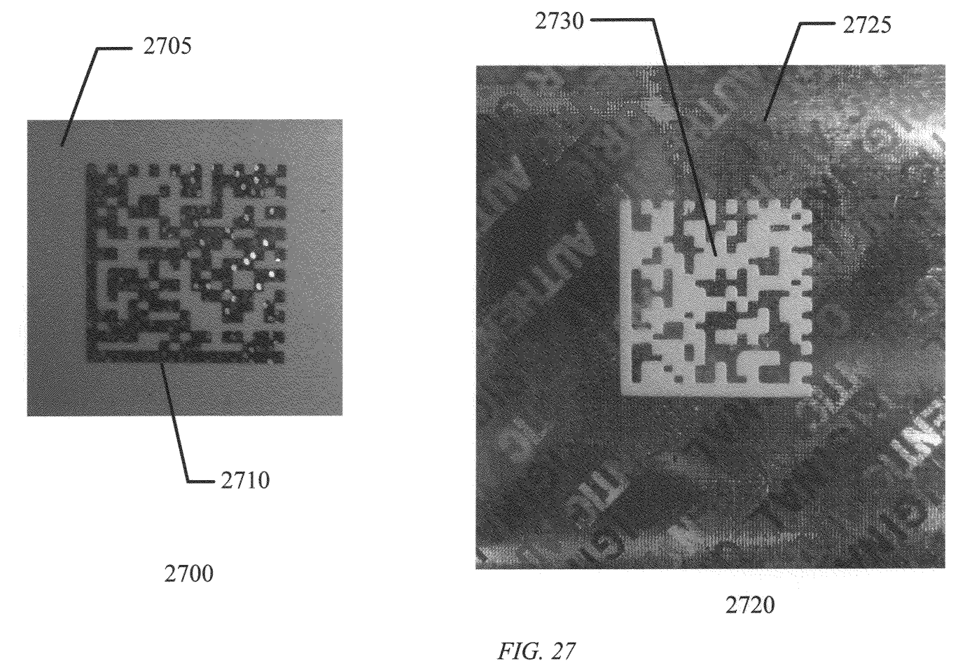

In order to determine the authenticity of a barcode by determining the presence or absence of multispectral features, the source of the multispectral features can be physically coupled with the barcode as tightly as possible. For example, if the barcode 505 and holographic backing 510 were laminated with a tamperproof clear cover, such cover would prevent the removal and replacement of the barcode 505 on the substrate 510. Alternatively, the substrate on which the barcode is located could be “optically plain” (i.e. not a multispectral material), but the laminated cover might have holographic security features incorporated in it as known in the art. Another alternative is to use holographic material to make a portion or all of the barcode itself. Two means of doing so are illustrated in FIG. 27. The positive elements of the barcode 2710 have been printed on optically plain substrate 2705. The material used for 2710 is a holographic thermal transfer ribbon available from Dai Nippon Printing and typically used for security markings on cards and the like. This form of holographic barcode is referred to herein as a “positive holographic barcode”. Equivalently, an opaque, optically plain thermal transfer ribbon may be used to print barcode 2730 directly on holographic substrate 2725 such as a security label 2725 as available from many sources. This form of holographic barcode is referred to herein as a “negative holographic barcode”.

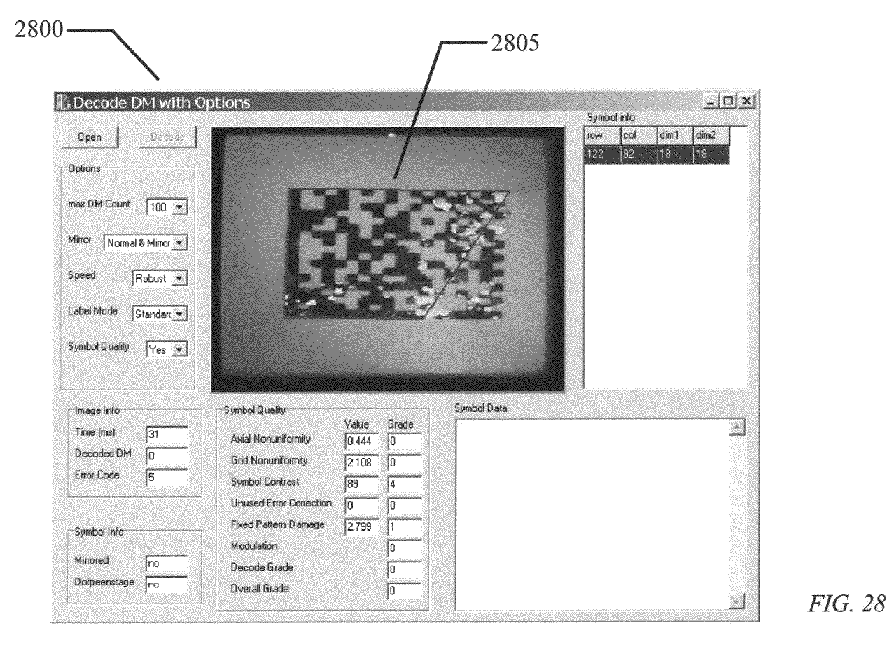

In general, the use of a holographic barcode as shown in FIG. 27 are problematic when used with conventional imaging systems. The image of a holographic barcode collected with any single illumination condition tends to have seemingly random regions of high- and low-light intensity. This variation of image intensity can corrupt the image of the barcode pattern severely enough that the pattern cannot be read and/or produces errors. FIG. 28 illustrates this situation. A single image of a positive holographic barcode was extracted from a multispectral image stack and has been presented to a commercial barcode reading software package. Screen shot 2800 is from this software package. Due to the intensity fluctuations, the commercial software 2800 was unable to properly identify the bounds of the barcode as indicated by the trapezoid 2805, which should exactly surround the barcode during proper operation. In this case, the barcode failed to be identified.

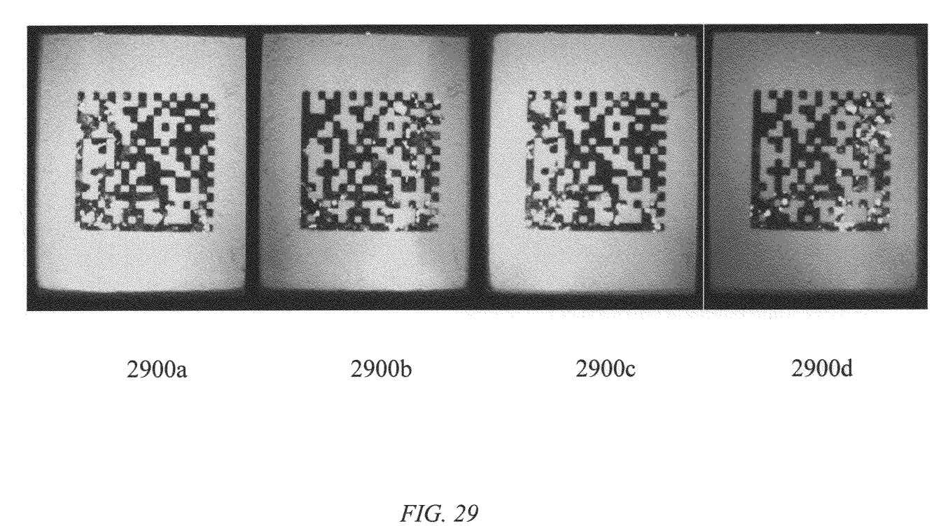

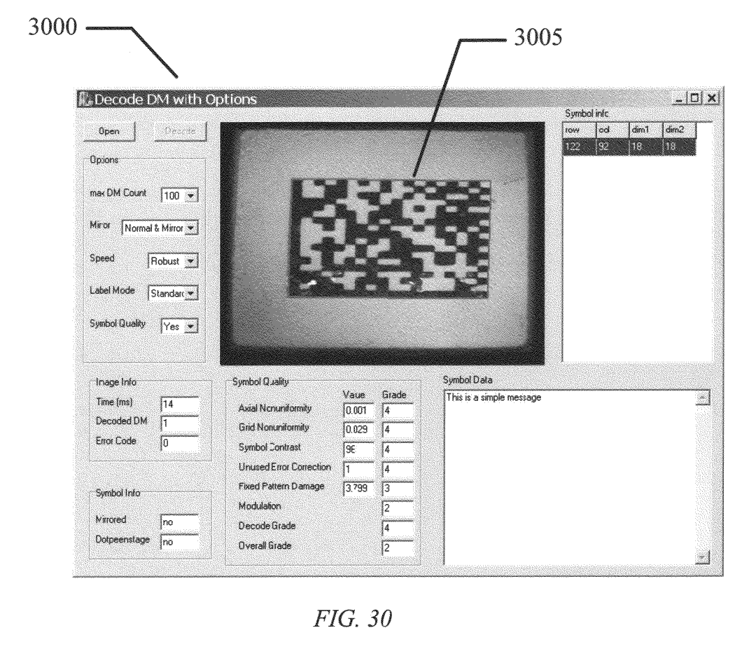

FIG. 29 shows four separate images 2900a, 2900b, 2900c, 2900d that were collected by a multispectral sensor. The bright illumination points can be seen to be different across the images corresponding to different illumination conditions. In order to produce a barcode that is better able to be identified and read without error, a pixel-wise minimum operation may be applied to the four co-registered images. In doing so, if at least one of the images at a certain location is not highly reflective, the pixel assigned pixel value will be much lower than the points of bright reflection. FIG. 30 shows image 3005 produced by the application of a pixel-wise minimum applied to the four planes of multispectral data shown in FIG. 29. Commercial software 3000 is able to properly detect and decode the barcode 3005.

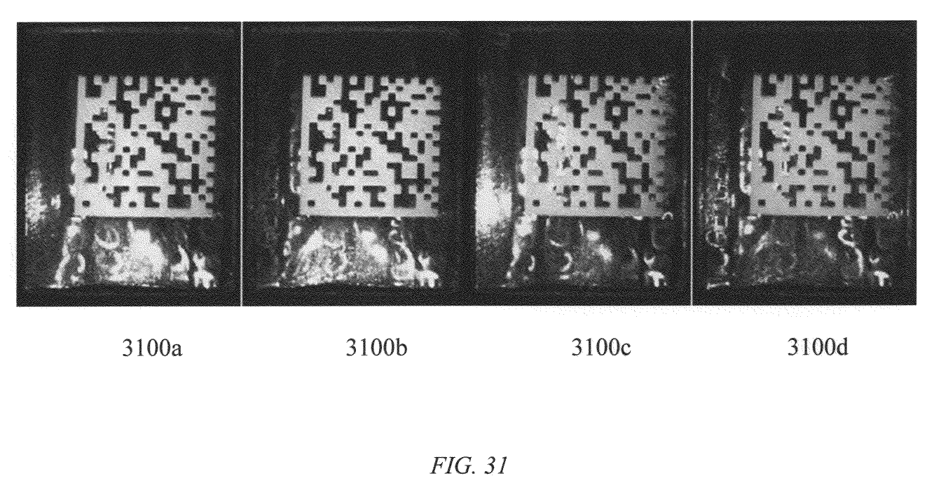

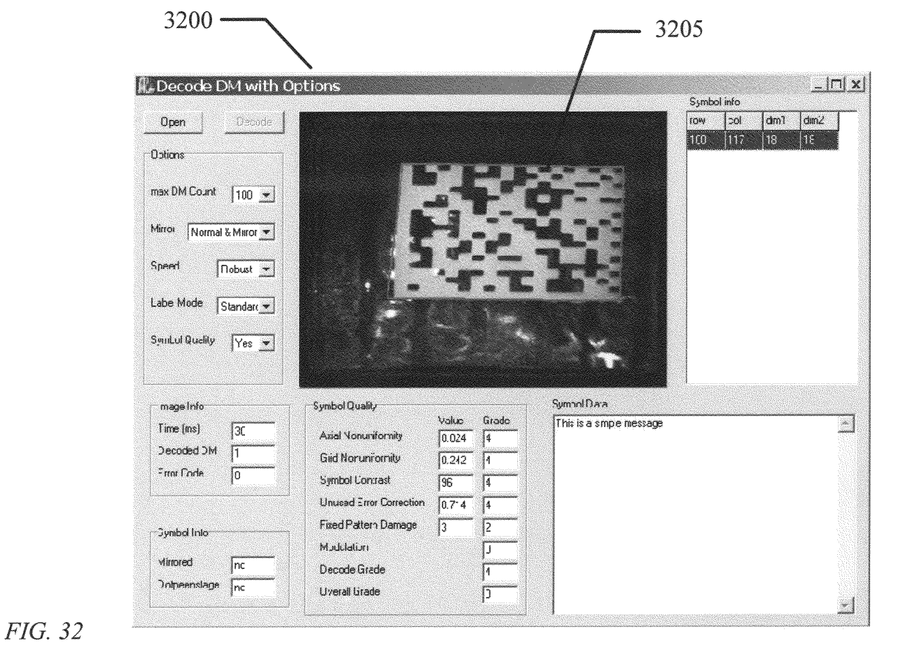

FIG. 31 shows the four multispectral data planes of a negative barcode, analogous to the positive barcode of FIG. 29. The commercial software also produced errors when trying to read any of the individual images. However, producing a composite barcode using the pixel-minimum operation described above produced a proper detection and reading as shown in FIG. 32.

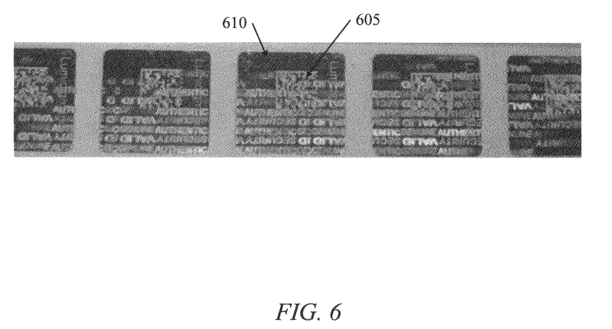

FIG. 6 shows a photograph of holographic security labels 605 with barcodes 610 printed using opaque thermal transfer resin, according to some embodiments. In some embodiments, the barcode is an opaque pattern printed on holographic material. Note the differences in color between the various holographic images based solely on imaging angle. While the barcode does not appear to be of high contrast when viewed under the illumination used for this photograph, when viewed by a multispectral sensor, the contrast of the barcode is enhanced greatly. Thus holographic labels can be used as a multispectral material with the barcode printed directly thereon.

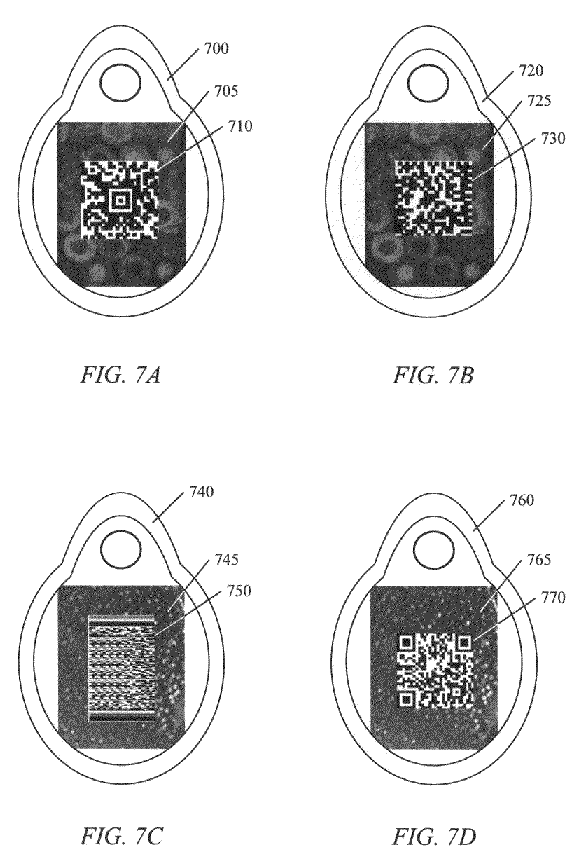

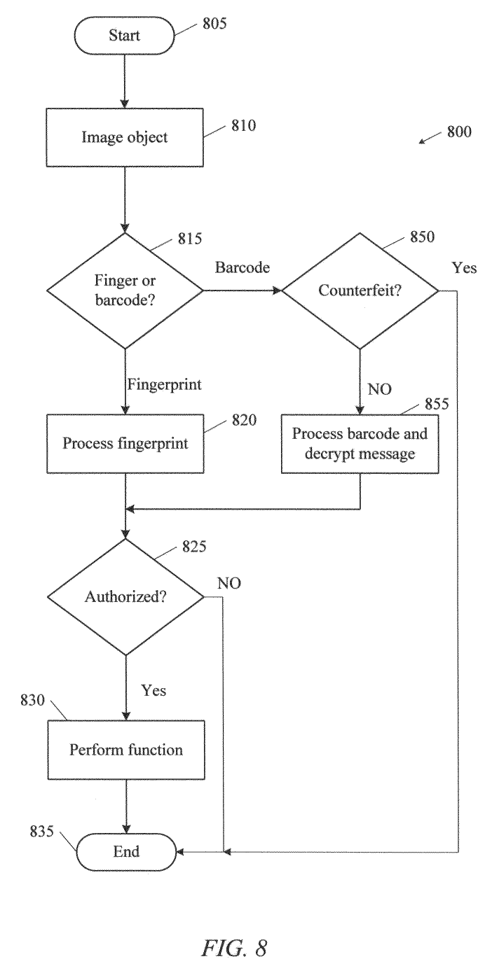

In some embodiments, a multispectral system can be used in a vehicle such as a truck, automobile, airplane, boat, train, fork lift, farm vehicle, construction vehicle and other such vehicles in lieu of keys or key fobs. A multispectral system can be used to allow a user (or users) to gain access to the vehicle and/or start the vehicle in multiple ways. For example, when a biometrically enrolled user presses the button or places a finger on the dashboard, the user's fingerprint can be imaged and the vehicle started if an authorized match occurs. In the event that user isn't biometrically enrolled or the enrolled biometric feature isn't available, a key fob with a barcode and/or multispectral material can also be used as an alternative authorization to gain access or start the vehicle. Key fobs 700, 720, 740 and 760 shown in FIGS. 7A, 7B, 7C and 7D can be used for such secondary access. Such key fobs can be used by valets, mechanics, or the like such that they can have access to the vehicle but without enrolling their biometric. FIG. 8, described below, shows a flowchart describing a process for using a secondary barcode. Key fob 700 in FIG. 7A shows Aztec barcode 710 placed over multispectral material 705. Key fob 720 in FIG. 7B shows DataMatrix barcode 730 placed over multispectral material 725. Key fob 740 in FIG. 7C shows PDF417 barcode 750 placed over multispectral material 745. Key fob 760 in FIG. 7D shows OR barcode 770 placed over multispectral material 765. Any type of multispectral material can be used with these key fobs. The barcode may contain multispectral material and/or other security markings which may be used by the multispectral sensor to authenticate the barcode as described elsewhere in this disclosure.

FIG. 8 shows a flowchart of process 800 for use with a primary and secondary authentication system according to some embodiments of the invention. While the secondary authentication described in process 800 uses a barcode, any type of barcodes can be used. In some cases the barcode may comprise of security markings that incorporate multispectral material. In some cases the barcode may be incorporated in a key fob or a card or a sticker or in a variety of other formats. Process 800 starts at block 805. At block 810 an object can be imaged using, for example, a multispectral system. In some embodiments, the process can be kept in a sleep mode until it is determined that an object has been placed at or on the imaging device. Various types of proximity sensing techniques can be employed such as optical sensing, capacitive sensing, electric field sensing, pressure sensing, and other such methods as known in the art.

At block 815, the process can determine if the object is a finger or a barcode. Moreover, any type of biometric can be substituted for a fingerprint. If the object is a finger, the image of the fingerprint is processed at block 820. Analysis of the fingerprint can include multispectral analysis, minutiae analysis, etc. At block 825, process 800 can determine whether the user is authorized by determining if the fingerprint matches previously enrolled fingerprints. If the user is not authorized, process 800 can end at block 835. At block 830 an authorized function can be performed if the user authorized, and then process 800 can end at block 835. In some embodiments, process 800 can return to block 810 rather than ending at block 835. At block 830, the performed function can vary based on the user or level of authentication provided to the user. The function can include, for example, starting a machine, process, computer, automobile, airplane, boat, or phone. The function can include, for example, opening a door to a safe, home, business, automobile, briefcase, airplane, boat, etc. Various other functions can be used.

If, however, at block 815 a barcode is imaged, then process 800 moves to block 850. At block 850, if the barcode is expected to contain security markings, it can be determined whether the barcode is counterfeit or not. For example, a barcode can be printed with or placed near or on or covered by multispectral material. A multispectral analysis of the barcode can determine whether the barcode is counterfeit or not. Examples of some counterfeit determining techniques are provided within this disclosure. If the barcode is counterfeit, then process 800 ends at block 835. If the barcode is not determined to be counterfeit or if no security markings are expected to be present on the barcode (e.g. when displayed on a cellular telephone), then process 800 proceeds to block 855. At block 855 the barcode can be analyzed and the message decrypted. Process 800 then proceeds to block 825 where authorization can be determined based on decrypted message.

### In Situ Biometric Enrollment

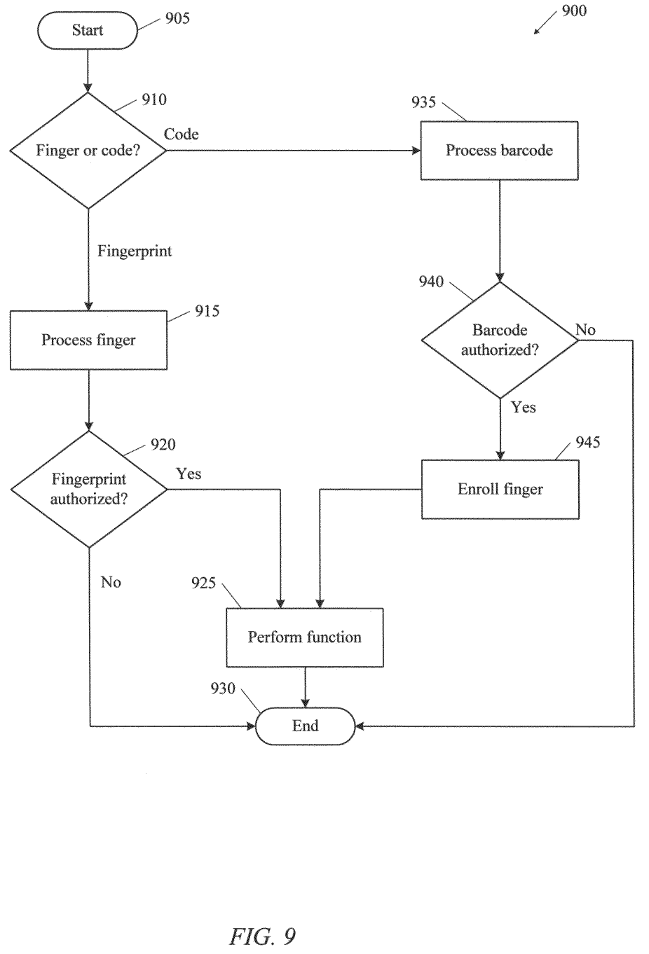

In some embodiments, alternative authorization may be combined with biometric authorization. For example, in the case of a biometrically controlled rental car, a barcode may be presented to the multispectral sensor in order to gain initial authorization and to trigger a biometric enrollment sequence. In another example, a piece of biometrically controlled equipment or a vehicle such a forklift in a factory may require that a barcode be presented to provide an initial authorization and trigger a biometric enrollment sequence. FIG. 9 is a flow sequence of process 900 of such an embodiment.

Process 900 begins at block 905. When the multispectral system is activated by some means process 900 determines if a finger or a barcode is presented to the sensor. This can be done by acquiring a single image or a multispectral image set and processing it to determine which type of object is present. Alternatively, a switch or other means can be used to indicate to the sensor which type of object is present. When a finger is presented, multispectral biometric data can be acquired (if not acquired already) and processed at block 915. Processing in this step may include biometric feature extraction and matching of minutiae data, pattern data and/or other means of biometric processing known in the art. The biometric features are then matched against the enrolled features to determine the degree of match between the present finger and any authorized enrollments. In the event that a match is determined at block 920, a function is performed at block 925. In some embodiments, process 900 can be used in a biometrically controlled vehicle, in such embodiments the function in block 925 can include authorization to start the vehicle and/or actually starting the vehicle and/or adjusting various settings of the vehicle according to user preferences. In some cases, the settings may include setting upper speed limits and other such characteristics for certain authorized drivers of the vehicle. In some embodiments, process 900 can be used by a biometrically controlled piece of equipment. In such embodiments, the equipment may commence operations or be authorized to commence operations. In some embodiments, process 900 can be used by a biometrically controlled automated teller machine (ATM). Functions performed at block 925 can include a deposit and/or a withdrawal, and/or various other banking processes. Other biometrically controlled applications will have analogous authorization to proceed with further functions.

Returning to block 910. If it is determined that a barcode is being presented to the system, process 900 proceeds to step 935. An image of the barcode can be acquired (if it hasn't already been acquired). At block 935, the authenticity of the barcode can be determined. In some embodiments, the barcode can further be decoded into a message. If the resulting message is encrypted, the message may be decrypted. The authenticity of the barcode (if determined) and/or the decrypted message (if encrypted) can then be used in step 940 to determine if the barcode is authorized. If not, then process 900 can ends at block 930. However if the barcode is authenticate and/or the message is proper, then process 900 can enter enrollment mode at block 945. During enrollment at block 945, the user may place his/her finger(s) on the sensor one or more times during which time the multispectral images are acquired and processed to extract biometric features. These biometric features can be recorded as enrolled and authorized biometric features. During this time user preferences (if applicable) may also be recorded. After block 945, the function can be performed at block 925 as described previously. Process 900 can then end at block 930. In some embodiments, process 900 can return to the initial state 905 rather than end at block 930. After this procedure, the user is biometrically enrolled in the system and may use the system with just his/her biometric as described in blocks 915, 920, and 925. In some embodiments, the biometric enrollment may be erased after a specific period of time or certain number of uses, requiring that an authorized barcode be presented to reactivate the enrollment procedure.

### Two-Factor Biometrics

In some embodiments, the acquisition of barcodes of proper form and/or meeting other constraints can be required for authorization in addition to collecting a fingerprint that matches an authorized fingerprint. Generally, such a requirement may be termed as “two-factor” authentication and is generally perceived to offer greater levels of security than either of the factors alone. In some cases, the barcode may contain an identifier of some kind that enables the multispectral system to select among a plurality of enrolled fingerprints and perform that fingerprint match against the enrolled fingerprint so selected. For example, the barcode may contain an address or pointer to an entry in a database of enrolled and authorized biometric features. The enrolled biometric features are then compared to the biometric features collected on the multispectral sensor taken near in time to the presentation of the barcode. In the event that the biometric features match those features indicated by the barcode, then authorization can be granted.

In other cases, the biometric matching may be performed using a local database or other means not directly facilitated by the barcode. However, final authorization is provided only after the biometric is confirmed to match the enrolled biometric AND a valid barcode is presented to the system.

### Biometric Barcodes

In one embodiment of the present invention, an image of a fingerprint or key characteristics thereof (e.g. minutiae locations, directions and types) may be contained in barcodes that are presented to and acquired by the multispectral system. Before, during, or after such acquisition of the barcodes, the multispectral system may also acquire a fingerprint from a living finger. The fingerprint from the living finger may then be processed in some way (e.g. extraction of features such as minutiae information or pattern information) which is then used to perform a biometric match against the biometric information contained in the barcode. In the event that the two biometrics are determined to match, some action may be taken such as providing an authorization signal. Other biometrics such as face and/or iris may be similarly recorded, acquired and matched by the multispectral system.

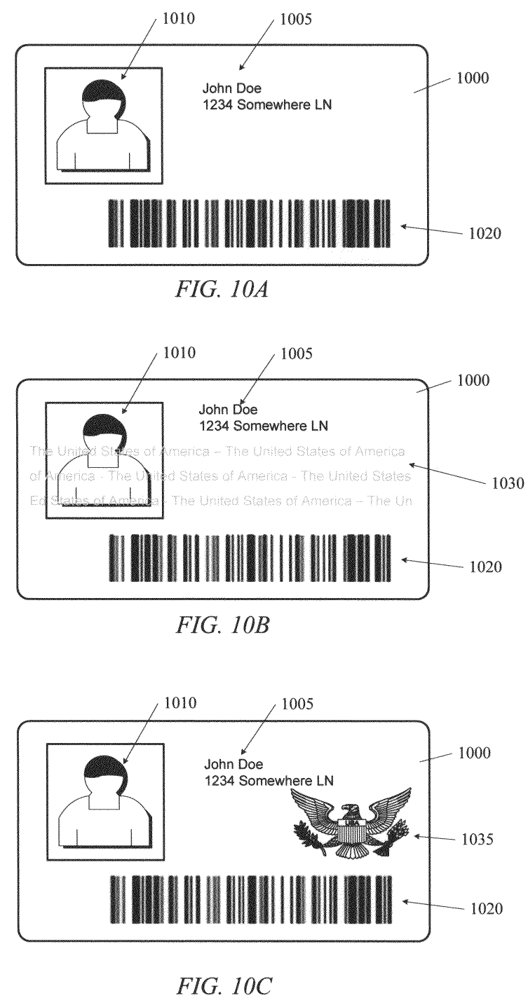

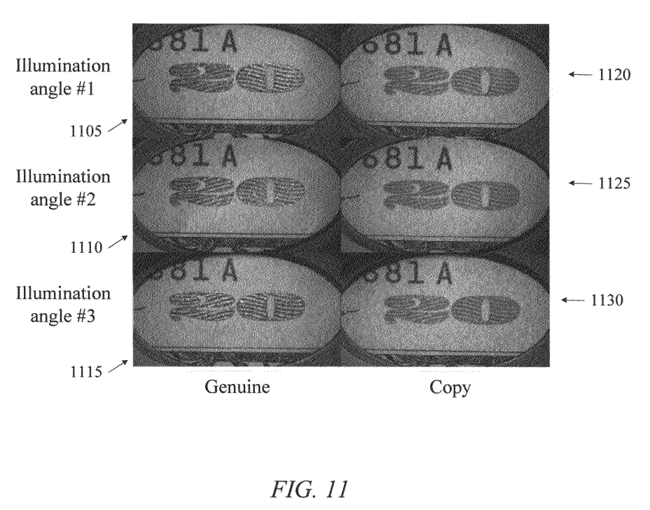

FIG. 10A shows a typical identification card 1000. Identification card 1000 can include card information 1005, photograph 1010, and barcode 1020. Other information can also be include such as a magnetic stripe, holograms, security codes, pictures, etc. Any type of barcode can be included. Identification card 1000 can include credit cards, drivers license, passport, loyalty cards, debit cards, licenses, club cards, government issued cards, etc. Biometric information encoded within the barcode can be extracted and matched with a biometric received from a user. Barcode 1020 can also encode information specifying the type of biometric information (e.g. minutiae locations, directions and types) encoded. When the biometric is read from the user, the proper biometric features are recorded and compared.

Identification card 1000 can also include various multispectral features. FIGS. 10B and 10C show identification card 1000 with multispectral features or materials. FIG. 10B shows identification card 1000 with holographic print 1030 printed over portions of the card. FIG. 10C shows identification card 1000 with a holographic image 1035 on the card. Holographic image 1035, for example, can be a white light hologram.

### Acquisition of Sensor Commands

In one embodiment of the present invention, barcodes may be acquired by the multispectral sensor which contain messages or code that sets, resets, or alters the operating mode of the multispectral system. For example, a barcode may contain an encrypted message that may cause the multispectral system to go into a diagnostic mode, allowing access to information and settings that can aid diagnosis and repair of the system. In some embodiments, such barcodes may cause the multispectral system to go into a supervisory mode, allowing access to functions such as database enrollment and un-enrollment, de-authorization, auditing, system programming, acquisition and/or copying of encryption keys, setting of system parameters, and other such actions. In some embodiments, such barcodes may cause the multispectral system to reset and/or reinitialize, which may include erasing some or all previously enrolled biometric data and/or other authorized data. In some embodiments, a certain barcode may be used to enable the multispectral sensor to undergo a one-way initialization during, for example, after the sensor is manufactured and before or during installation at the customer site or application.

### Acquisition of Ambient Lighting Conditions

In one embodiment of the present invention, the multispectral sensor may acquire information about the ambient lighting condition while not being used to acquire a fingerprint image (or collect such information in conjunction with a fingerprint image). The multispectral system may then process the ambient light conditions and take an action accordingly. For example, in some cases, the multispectral system may increase illumination light levels when the ambient light levels are relatively high and decrease illumination light levels when ambient light levels are relatively low. In some embodiments, ambient light levels can be detected and interior lighting, dashboard lighting, and/or headlights can be adjusted accordingly.

### Embodiments of Tangible Barcodes and Forgery Detection Thereof

In some cases, the barcodes may be printed on an identification card such as a laminated card issued by a business or government agency. In some cases, the barcodes may be on a card such as a driver's license. In other cases, the barcodes may be printed on a piece of paper by a LaserJet printer, inkjet printer, impact printer, or other such means. In some cases, the barcodes may be printed on a substrate with an adhesive backing. Such substrate may be adhered in other convenient locations such as the back of an electronic fob, on the back of a driver's license, or on an identification card of some kind. In some cases, such substrate may be designed to tear upon removal or contain other features to thwart tampering as known in the art.

In some cases, some form of forgery detection may be included with the barcodes or with the substrate that the barcodes is printed on, or with the laminate cover placed on top of the printed barcodes. In some cases, forgery detection may be performed directly by the multispectral system using images acquired by the multispectral sensor. In some cases, forgery-detection may use features such as watermarks, color-changing links, holograms, micro-text, spectral and/or textural characteristics of the substrate or a laminated cover, and other such features. Two examples of forgery detection are provided below:

### Color-Changing Ink

Various embodiments of the invention can use multispectral material or multispectral features. Color-changing or optically-variable ink can be used as one example of a multispectral material or feature. In some cases color changing inks change colors as a function of imaging angle or illumination angle. Such ink is used currently on some US paper currency as well as many other currencies throughout the World. As an example, a portion of a genuine United States twenty dollar bill using color changing inks and a color copy is shown in FIG. 11. Images 1105, 1110, and 1115 were acquired by a multispectral system using white light at three different illumination angles and captured by a color camera. Images 1120, 1125, and 1130 are images of a copy of the 20 dollar bill acquired by the same multispectral system using white light at the same three different illumination angles and captured by a color camera

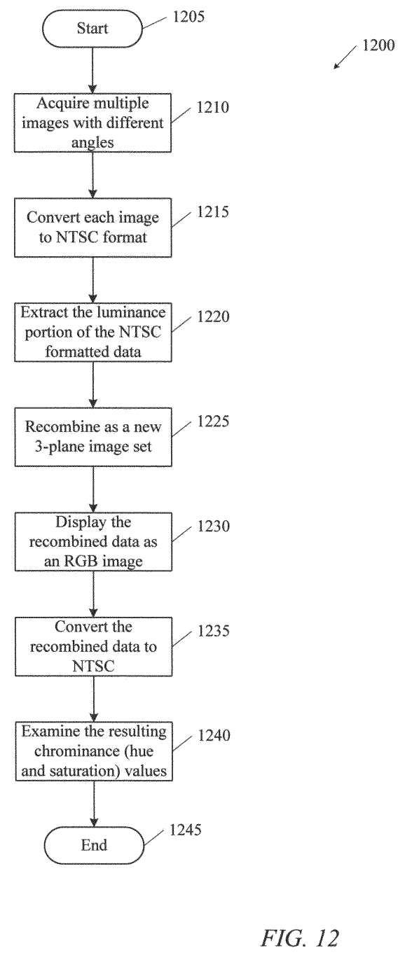

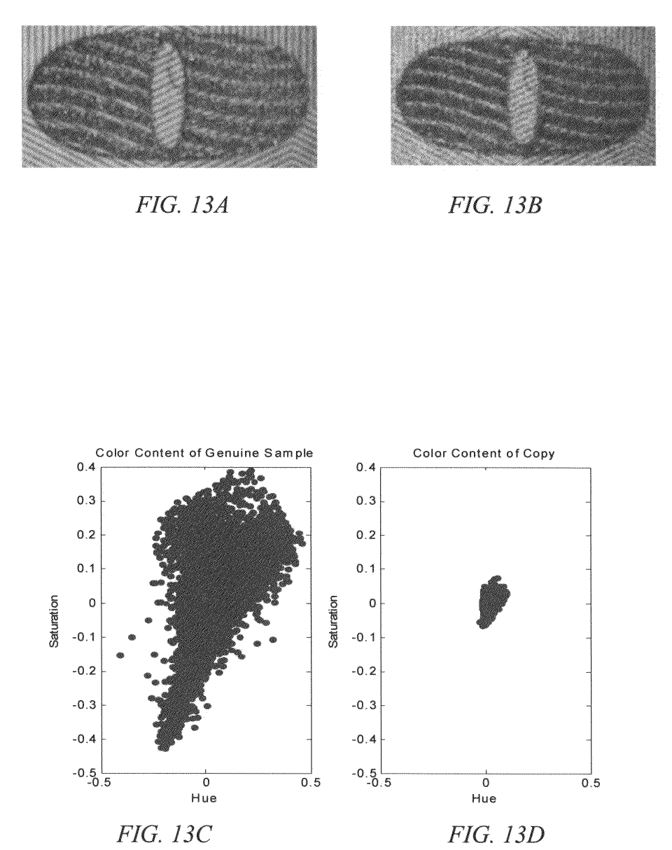

Differences between the three multispectral images can be seen and quantified in a multitude of ways. FIG. 12 shows flowchart of one method 1200 of showing such differences. Method 1200 starts at block 1205. At block 1210, RGB color images can be acquired under different angles. The images can be acquired under different illumination angles or imaging angles. In some embodiments, three images can be acquired, in others two, four, five, or more images can be acquired. At block 1215, each of the images can be converted to NTSC format. At block 1220, the luminance (intensity) portion of the NTSC formatted data can extracted, and the images can be recombine as a new 3-plane image set at block 1225. At block 1230, the recombined image can be displayed as an RGB image (see FIG. 13A). The differences in the recombined luminance values can be quantified by converting the recombined image data to NTSC at block 1235, and examining the resulting chrominance (hue and saturation) values at block 1240.

FIG. 13A shows a recombined luminance image from the three genuine images 1105, 1110, and 1115 shown in FIG. 11. FIG. 13B shows a recombined luminance image from the three copied images 1120, 1125, and 1130 shown in FIG. 11. FIG. 13C shows the hue and saturation values from the genuine image in FIG. 13A, and FIG. 13D shows the hue and saturation values for the copied image in FIG. 13B. The differences in the hue and saturation values are easily quantified.

This analysis maps differences in the images due to different illumination angles to changes in hue and saturation values. Color changing ink thus shows a large amount of change as a function of illumination angle. Hence, the resulting hue and saturation values vary a great deal. The ink in a color copy of a genuine bill does not change much with respect to illumination angle. Accordingly, the corresponding hue and saturation plot shows little change. Such changes may be used to determine whether a particular substrate is genuine or a forgery attempt.

### White-Light Holograms

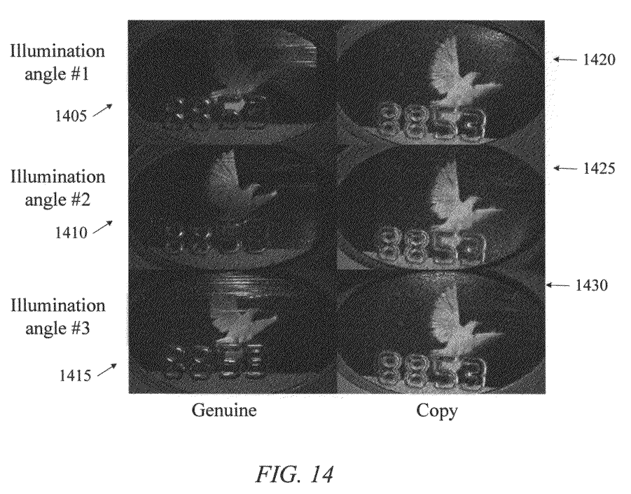

A multispectral system can be used to detect forgeries using white light holograms in the a manner similar to process 1200 described in FIG. 12. Such holograms are present on many credit cards, business identification cards, tickets to sports events and shows, and other sorts of credentials. FIG. 14 shows images 1405, 1410, and 1415 of a white light hologram acquired by a multispectral system using white light at three different illumination angles and captured by a color camera. Images 1420, 1425, and 1430 are images of a copy of the same white light hologram and acquired by the same multispectral system using white light at the same three different illumination angles and captured by a color camera.

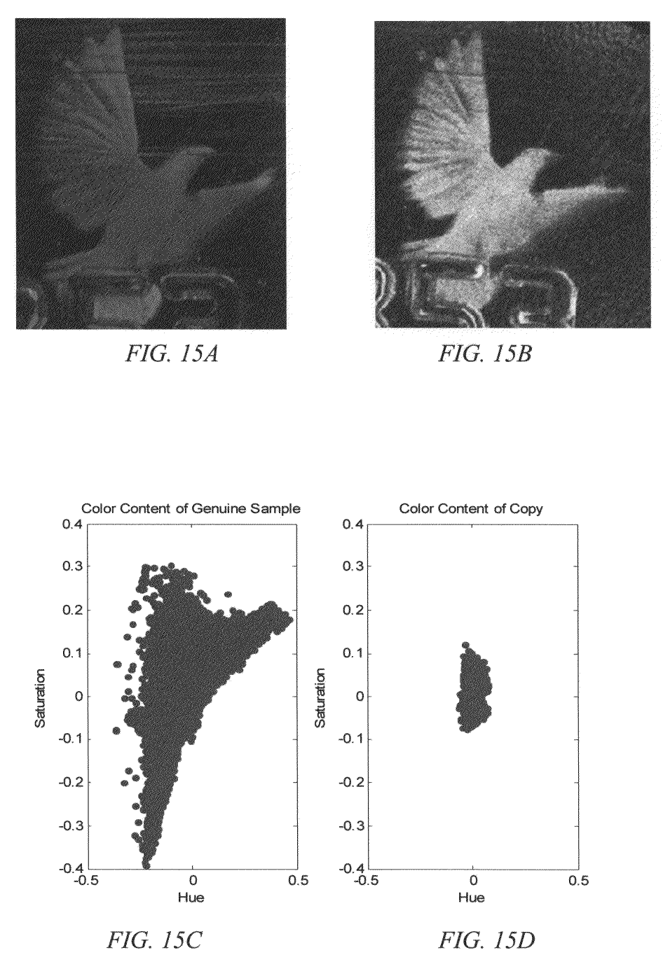

FIG. 15A shows a recombined luminance image (generated in a manner described earlier in this disclosure) from the three genuine images 1405, 1410, and 1415 shown in FIG. 14. FIG. 15B shows a recombined luminance image from the three copied images 1420, 1425, and 1430 shown in FIG. 14. FIG. 15C shows the hue and saturation values from the genuine image in FIG. 15A, and FIG. 15D shows the hue and saturation values for the copied image in FIG. 15B. The differences in the hue and saturation values are easily quantified.

### Biometric and Document Capture

In some embodiments of the invention, a multispectral system can image both biometric data and documentation. In some embodiments, the multispectral system can incorporate a whole-hand sensor that is large enough to also capture images of documents and/or barcodes. Such systems can be used, for example, at airports to capture biometrics and passports. Multispectral systems can provide counterfeit detection and can mitigate document capture errors such as glare.

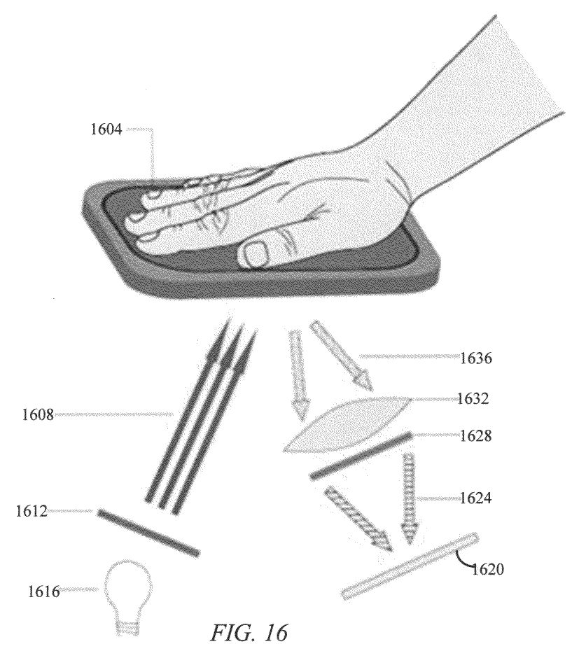

FIG. 16 shows a whole hand sensor according to some embodiments of the invention. The hand of an individual may rest on platen 1604, with illumination light provided with illumination source 1616. While a single illumination source is shown multiple illumination source can be included. These illumination sources can illuminate the hand with different wavelengths of light, different polarization directions, and/or with different illumination angles. In some instances, the light may be polarized 1608 by a polarizer 1612 disposed between the illumination source 1616 and the platen 1604. Light scattered 1636 from the hand is collected by an imagining array 1620. While only a single imaging array is shown, multiple imaging arrays can be used. These different imaging arrays can image at different imaging angles, at different frequencies, at different polarizations, etc. The scattered light 1636 may be imaged onto the array 1620 by an imaging lens 1632 and may be polarized by a polarizer 1628 so that polarized light 1624 is incident on the imaging array 1620. In some embodiments, the polarizers 1612 and 1628 are provided in a crossed configuration so that any light that passes through the illumination polarizer 1612 and undergoes a secular or surface reflection into the imaging system is substantially attenuated by the imaging polarizer 1628. This arrangement emphasizes light that has passed into the skin and been subjected to multiple optical scattering events before being imaged. In some embodiments, the system has multiple direct illumination LEDs that turn on sequentially. Some of the LEDs might not have polarizers in front of them, causing the hand to be illuminated with essentially randomly polarized light. Such an illumination state allows a greater portion of surface-reflected light to be imaged.

In addition to the polarized and unpublicized direct illumination LEDs, the system may also comprise an illumination state that uses light from LEDs that illuminate an edge of the platen. A portion of this light is trapped within the platen because of total-internal-reflectance (“TIR”) phenomena and propagates through the platen. At points where the skin is in contact with the platen, the TIR effect is negated and light is able to enter the skin. Some of the light is diffusely reflected back out of the skin into the imaging system, producing an image of the contact regions.

While not shown in the embodiment of FIG. 16, some embodiments may include locating devices that provide weak or strong constraint on the position and/or configuration of the hand relative to the platen. Examples of such locating devices include pegs that may be disposed between individual fingers to provide a defined spacing of the fingers relative to each other. But such locating devices are not required in all embodiments of the invention and embodiments like that shown in FIG. 16 that have no such locating devices are within the intended scope of the invention.

In addition, various alternative embodiments of the structure shown in FIG. 16 may include mirrors, prisms, multiple cameras, and/or other optical mechanisms to provide different levels of information captured by the system. For instance, such optical elements may be configured to capture a larger or smaller portion of the thumb, greater or lesser fingerprint information, and so on.

Moreover, multiple wavelengths and multiple illumination angles can be used. The platen can be designed to have an area to capture hand prints as well as documents. For example, the platen can have a 6 inch by 9 inch capture area. In some embodiments, high resolution images can be produced of an entire hand. Such resolution can provide substantial information that can be used for secure authentication.

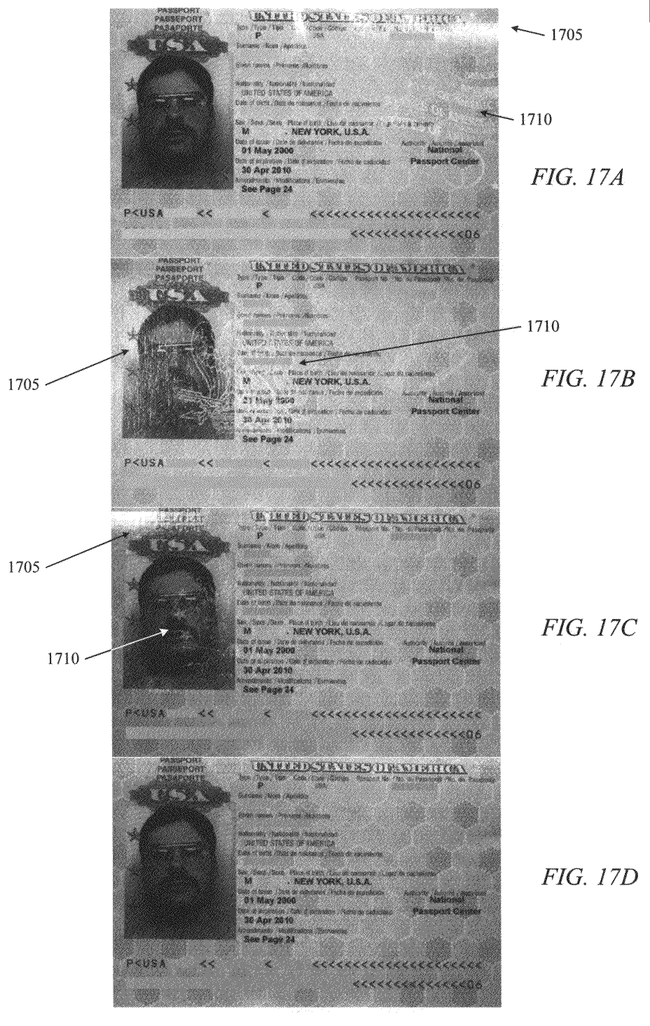

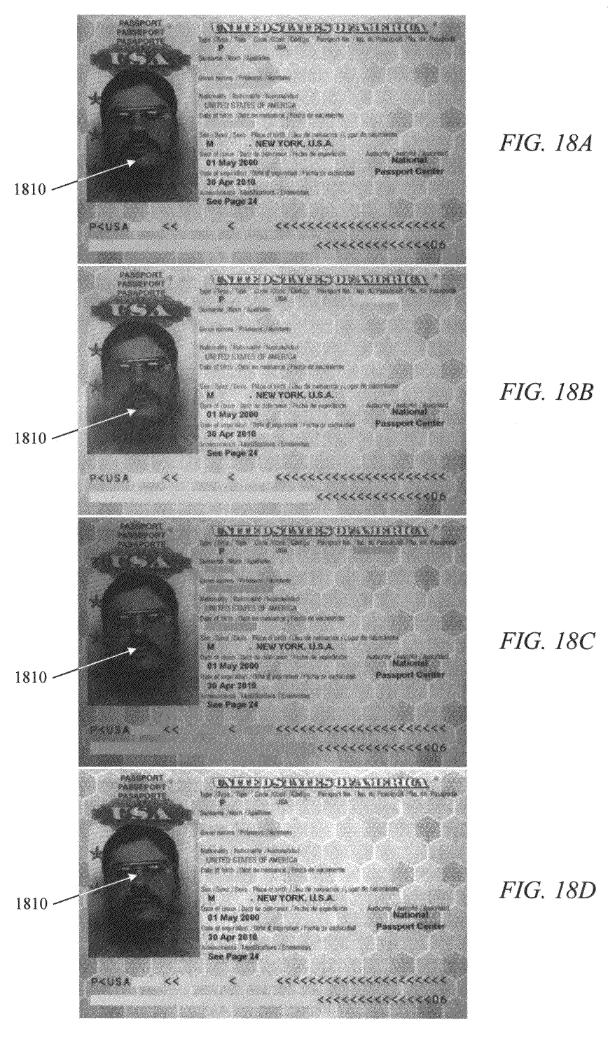

In some embodiments, document capture can provide counterfeit detection. FIGS. 17A, 17B, and 17C show images of a passport produced with non-polarized illumination at different illumination angles. As can be seen in the images, the position of glare 1705 varies from image to image based on the different illumination angles. Moreover, different holographic features 1710 are visibly present on the passport depending on the illumination angle. FIG. 17C shows the same passport illuminated with cross-polarized light. This illumination scheme can be used to capture barcodes from the document.

FIGS. 18A, 18B and 18C show images of a copy of the same passport produced with non-polarized illumination at different illumination angles. In these figures, some security features are visible under all illumination conditions and some security features seen in FIG. 17 are not present in any of FIG. 18 images. In some embodiments, an indication that security features are present or absent among most or all illumination conditions can be used as one indication to show that the document is counterfeit.

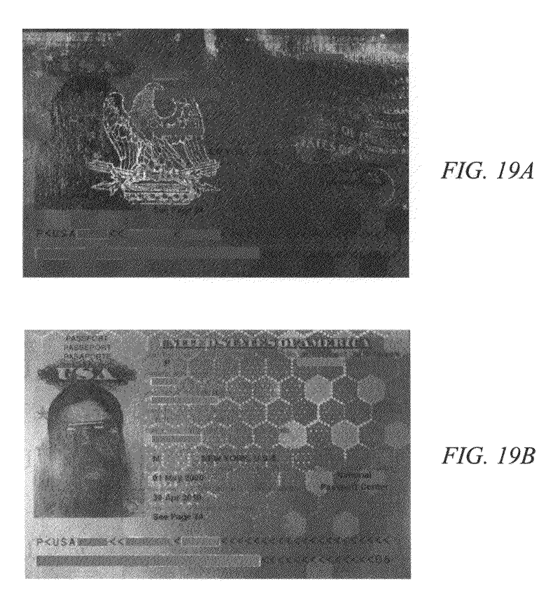

FIG. 19A show pseudo color images created from FIGS. 17A, 17B, 17C, and 17D. FIG. 19B show pseudo color images created from FIGS. 18A, 18B, 18C, and 18D. These pseudo color images highlight regions with the most change between illumination conditions, which exposes holographic features. The strong showing of holographic features in the pseudo color image in FIG. 19A indicates that this is from a genuine document. Likewise, because the holographic features are not clearly present in FIG. 19B, it is likely that the document is a copy.

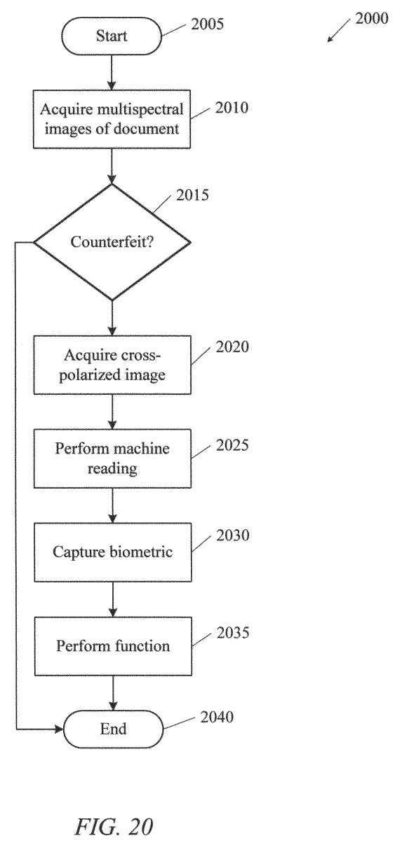

Thus, process 2000 for reading and authenticating machine readable documents along with biometric data is shown in FIG. 20. Process 2000 starts at block 2005. At block 2010, a block can be presented and multispectral images of a document can be produced. At block 2015 it can be determine whether the document is a counterfeit or not. For example, by combining images from different illumination angles and noting the regions with the most change between images. If the document is determined to be counterfeit, process 2000 can end at block 2040. At block 2020 a cross-polarization image can be acquired, and barcodes recorded at block 2025. Barcodes recording can provide information from the document. At block 2030 a biometric can be captured using same imaging system. For example, an entire hand can be imaged. In some embodiments a function can then be performed with any or all the captured data. For example, a comparison between information derived from the machine readable information and information stored in memory about the recorded biometric can be made. With this comparison, authentication, approval, access, validation, etc. can be performed. Process 2000 can then end at block 2040.

### Timed Access

In some embodiments of the invention, a barcode can be used to established authorization for use for a specific period of time. For example, a machinist may be trained for operation of a specific machine. The machinist can simply scan their barcode that can include biometric information, time for authentication, and/or machine preference data. Each morning the machinist can scan their barcode and gain access to the machine. Throughout the day, when the machinist uses the machine, he can simply provide his finger for a biometric image and the machine can allow access. Access can be reset every shift, every hour, every day, etc. and require another barcode scan. Moreover, if the machinist requires periodic training, the barcode can include information specifying the date or time when authentication ceased.

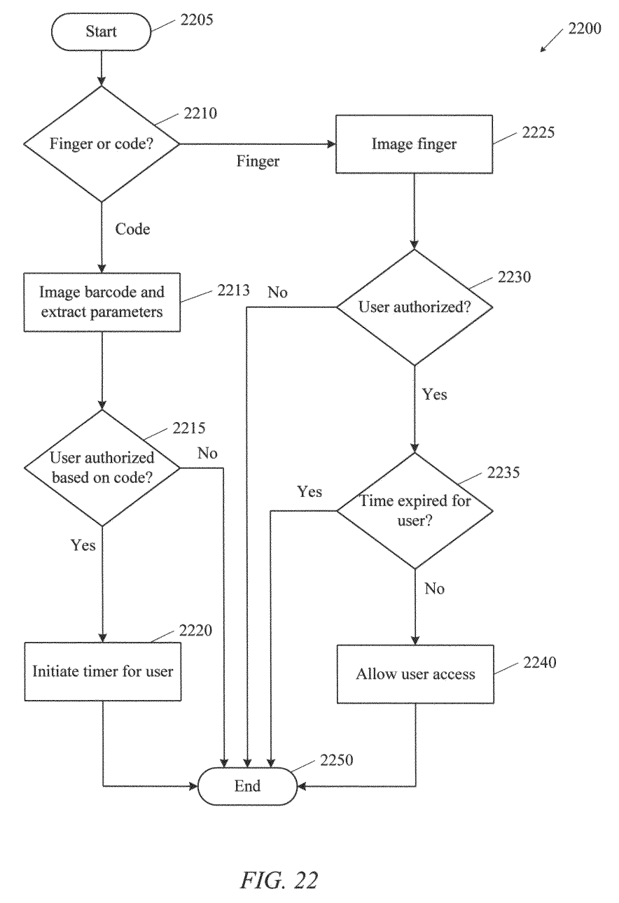

An example of timing process 2200 is shown in flowchart form in FIG. 22. Process 2200 starts at block 2205. At block 2210 a finger or code is imaged. If a finger is imaged, process 2200 proceeds to block 2225. If a code is imaged, process 2200 proceeds to block 2215. At block 2213 the barcode can be imaged and various parameters extracted. These parameters can include user preferences, user identification, biometric template(s), and/or time periods. Based on the user identification or other coded data, it can be determined whether the user is authorized at block 2215. If the user is not authorized, process 2200 ends at block 2250. Otherwise, at block 2220 the user is authorized and access can be provided.

At block 2225 a fingerprint (or any other physical characteristic) of the user can be imaged and biometric template created. A comparison between a biometric template received from a barcode (e.g. at block 2215) and this biometric can be made at block 2230. If they do not match, authorization is denied and process 2200 ends at block 2250. If they do match, process 2200 checks, at block 2235 whether the time is within the allowed access time. For example, by comparing the current time with a time received from the barcode and stored in memory. If the time has expired, process 2200 ends at block 2250. If the time has not expired, then access is allowed at block 2240. In some embodiments, two time periods can be captured: The amount of time a user is authorized to gain access in one period of time, and/or the amount of time the between uses before the expire and requiring another scan of the user's barcode.

### Digital Barcodes

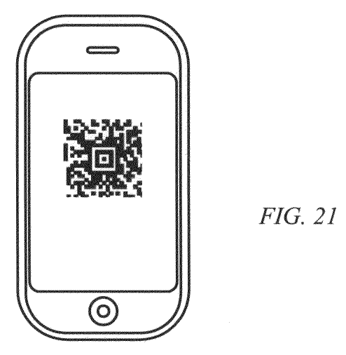

In some embodiments described herein, barcodes may be presented to a multispectral sensor in digital form. For example, barcodes, may be displayed on a handheld device such as a cell phone, PDA, net book, laptop, or other such device as shown in FIG. 21. Such a digital display may be presented to the multispectral sensor directly for acquisition as an alternative to printing the barcodes on paper or other media before acquisition.

In some embodiments, the digital barcodes may contain a time stamp, time marker or some other means to limit the duration and/or the number of uses of such information to gain authorization or to be used in conjunction with gaining authorization.

In some embodiments, a business or other organizational entity may have a database of employees and/or other individuals who are authorized certain access. This database can include biometric data. The business may further have biometric data corresponding to each employee. Periodically, perhaps nightly, such business may send barcodes to the authorized cell phones of authorized individuals. Such barcodes may contain the authorized biometric information in a form usable for subsequent two-factor biometric matching. Alternatively such barcodes may provide a means of alternative authorization. In either case, such barcodes may be usable for a specified period of time or just during a specified time interval. In some cases such barcodes may just be usable during business hours during the day following the sending of such data. Upon receipt, an authorized individual may present the barcodes to the multispectral sensor using their authorized cell phones. In the event that the barcode contains an alternative authorization message, the authorization may be granted after the message is received and perhaps decrypted by the multispectral system. In the event that such barcodes contains biometric data (e.g., fingerprint data) the individual seeking authorization may then present their finger to the multispectral sensor wherein a fingerprint is acquired. The multispectral system then determines the degree of similarity between the two fingerprints. In the event that the two fingerprints are determined to be sufficiently similar, authorization may be granted by the multispectral system or other such actions may be taken.

### One-Time Access

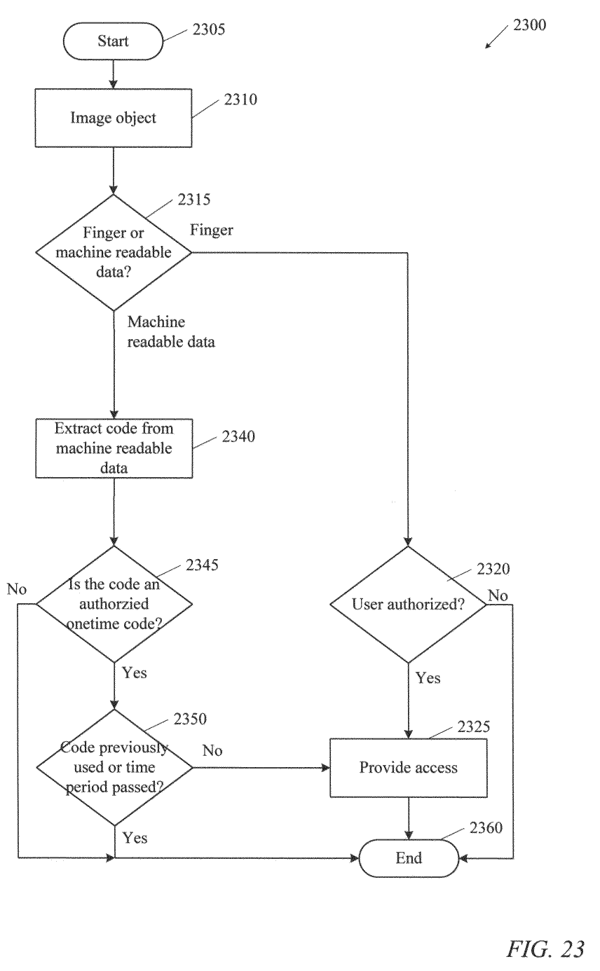

FIG. 23 shows a flowchart of process 2300 for allowing both biometric and one-time access according to some embodiments of the invention. A one-time code can be provided in the form of barcodes through a screen on a phone, mobile computing device, laptop, PDA, etc., as shown in FIG. 21. The barcode can be sent to the device via email, a web browser, or through MMS messaging. Process 2300 starts at block 2305. At block 2310 an object can be imaged. If the object is a finger (or other physical feature of the user), process 2300 proceeds to block 2320. Biometric features of the finger can be extracted and/or a biometric template created. Based on these biometric features and/or template the user can be authorized at block 2320. If they are authorized, access can be granted at block 2325 and process 2300 can end at block 2360. If the user is not authorized based on their biometric at block 2320, process 2300 can end at block 2360.

If, however, at block 2315 it is determined that a barcode was imaged, process 2300 can first extract an authorization code from the barcode at block 2340. Extracting codes or messages from barcode can include one or more of the following. In some embodiments, it can first be determined whether the barcodes is counterfeit as described elsewhere in this disclosure. In some embodiments, a message can be decoded from the barcode. In some embodiments, this message can be the authorization code or part of the message can include the authorization code. In other embodiments, the message can be encrypted, thus decryption can be used to produce the authorization code from the message.

At block 2345 it can be determined whether code is a valid one-time authorization code. This determination can occur by using a mathematical process to determine whether the one-time code is authorized. For example, all one-time authorization codes can have the same checksum. In other embodiments, a number of the one-time codes can be saved in memory and a comparison between the code and the one-time codes in memory can occur to determine if the code is authorized. In some embodiments the one-time code may contain a simple numeric value that is incremented after each use. In some embodiments, if the code is authorized, then the one-time code in memory can be deleted and/or flagged as previously used. In some embodiments, the code can be saved as a previously used one-time code. Regardless of how previously used one-time codes are indicated, at block 2350 it can be determined if the code has been previously used by referencing one of these memory locations. If the authorization code has previously been used, then access is denied. Otherwise process 2300 proceeds to block 2325.

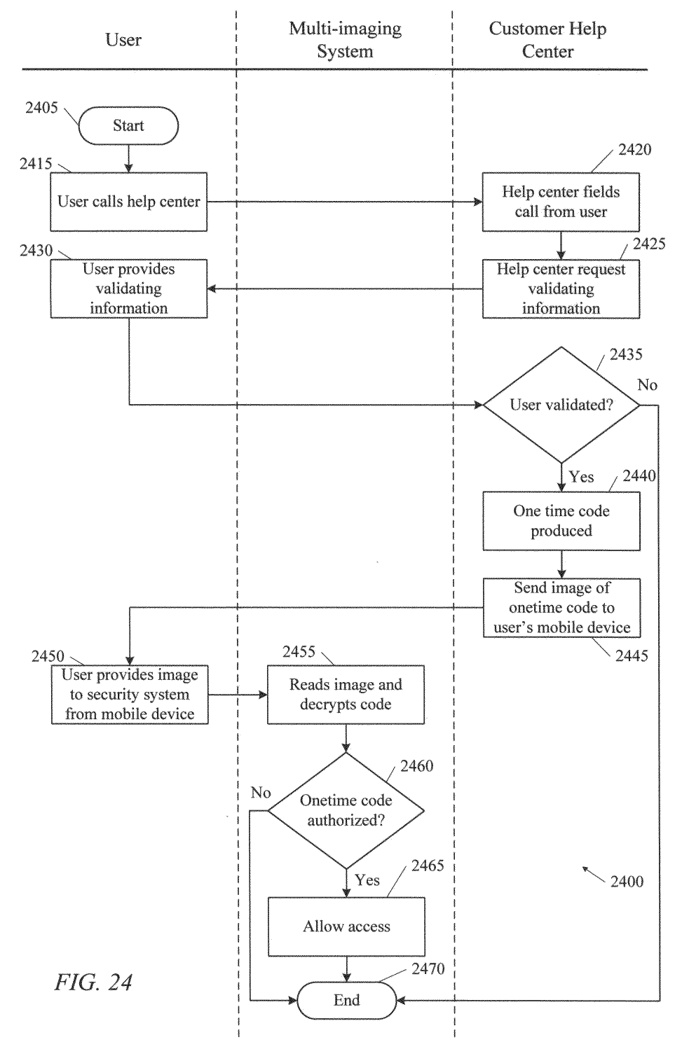

FIG. 24 shows another embodiment providing one-time access. Process 2400, for example, can be used to provide access to an automobile when the user is locked out or the automobile does not start with their fingerprint. Process 2400 starts at block 2405. At block 2415 a user calls a customer help center and the call is fielded at the customer help center at block 2420. Validating information can be requested by the customer help center at block 2425. This information can be provided by the user at block 2430. Validating information can vary and can include any type of information that can be provide over the phone to validate the user. For example, validating information can include birth date, social security number, address, passwords, personal identification numbers, answers to user-specific questions, etc. If the user provides the proper validating information, then the user is validated at block 2435. If validation fails then process 2400 can end at block 2470.

If the user is validated then a one-time authorization message can be produced. For example, a general message (or one of many general messages) that indicates that the user is authenticated or that can allow access can be used. In some embodiments, the authorization message can be a bitmask message. In some embodiments, the authorization message can be retrieved from a set of authorization messages and/or can be a previously unused authorization message. In some embodiments, the authorization message can be encrypted with a private key or with another cryptography method. The message can then be encoded within, for example, a barcode. The barcode can then be sent to the user at block 2445. For example, the barcode can be sent to the user's device, address or number on file. An image of the barcode can be presented by the user to the multispectral system at block 2450. At block 2455 the image can be read by the multispectral system and the message can be decrypted using a public or private key or other cryptography method. If the message is an authorized message as determined at block 2460, then the user is allowed access at block 2460. If the code is a one-time code then the multispectral system can flag the one-time code as used and deny access to future users using the same code. In some embodiments, an internal counter can keep track of the next usable authentication message.

### Two Factor Authentication

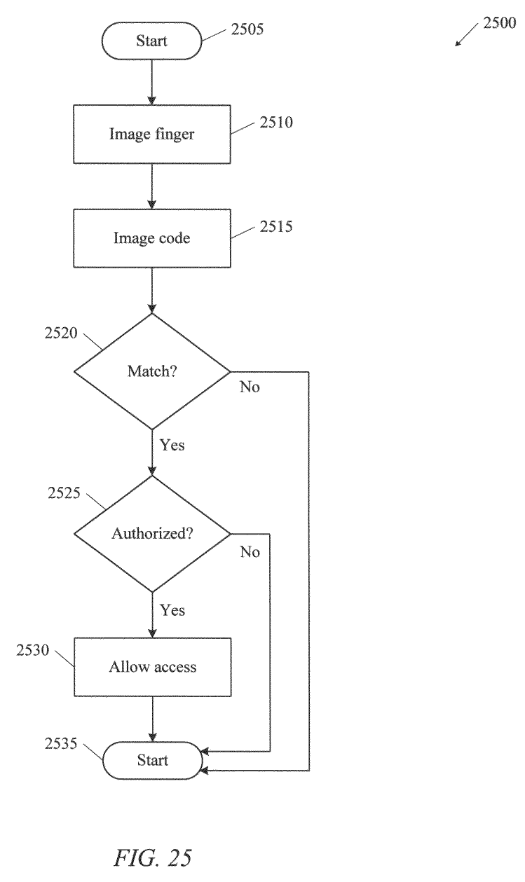

Some authentication policies require two factor authentication. That is an authentication scheme where two different factors are used in conjunction to authenticate a user. In some embodiments, two factor authentication can be initiated using a multispectral system. FIG. 25 shows a flowchart of process 2500 for authenticating a user with a two factor authentication using a multispectral system. Process 2500 starts at block 2505. At block 2510 a fingerprint is imaged, and a barcode is imaged at block 2515. A biometric template or features can be extracted from the fingerprint image. In some embodiments, the barcode can encode a biometric template or features. The biometric template and/or features can be decoded from the barcode. If the biometric template and/or features extracted from the code match those extracted from the fingerprint image at block 2520, then process 2400 proceeds to block 2525. If they don't match then process 2500 ends at block 2535. In some embodiments, even though a match has been found, user access can still be restricted. Thus, at block 2525, process 2500 can determine if the user is authorized for access. If they are not authorized, process 2500 ends at block 2535. If they are authorized then process 2500 can allow access at block 2530.

### Use of Encryption

In some cases, some or all of the barcodes used by a multispectral system may be encrypted in some manner. In some cases the encryption may be a symmetric encryption, using a single, secret key to encrypt and decrypt the information. In some cases the encryption may be asymmetric encryption using an encryption key pair which is usually described as a public key and private key pair. For example, the barcodes may be encrypted using a public key. Once the multispectral system acquires the barcodes, the encrypted data may be decrypted using the proper private key, which may be securely contained in the multispectral system. In some cases the private key may be unique to a particular multispectral system or may be the same as some other group of multispectral systems which enables interchangeable operation within a designated subset of multispectral systems but not necessarily across all multispectral systems. In some cases a combination of symmetric and asymmetric encryption may be used to, for example, transmit a symmetric key by encrypting it using asymmetric encryption. Digital signing and other such uses of encryption as known in the art may also be incorporated in the barcodes and/or multispectral system.

### Physical Embodiments of a Multispectral System

In some cases, the multispectral system may be a self-contained unit containing an illumination subsystem, the imaging subsystem, the platen, the computational system and memory, and all other necessary components for self-contained acquisition and processing of said MI data. In some embodiments, the computational system and/or the memory and/or some portion of each may exist outside of the unit containing the rest of the multispectral system. In some cases, the external computational system and memory may be a host computer.

In another embodiment, the multispectral system may use a window or other suitable piece of glass, plastic or other material as the platen. For example, a multispectral sensor intended for use by people wishing to gain access into a transportation vehicle may be mounted in such a way that one or more sections of the external window glass of the transportation vehicle are used as the platen. Similarly, external windows of businesses, houses and other structures may be so used. Also, protective glass in front of tellers and the like may be used in a similar manner. In all such configurations, the illumination, imaging and computational subsystems of the multispectral sensor may be mounted on or near the interior side of the glass in proximity to the location to be used by the user and oriented such that the illumination subsystem illuminates through the glass and the imaging subsystem images through the glass. In use, the user may place a finger on the external window surface for a period of time to collect MI biometric data. Such configuration of the multispectral system may also be used to acquire barcodes and/or other biometric modalities.

Multispectral System Coupled with Alcohol Measurement

In some embodiments of the present invention, the MI fingerprint sensor may be built into a system that also includes an alcohol measurement system or a system for measuring one or more other such substances that might be ingested and present within the skin and/blood. This disclosure uses the terms “alcohol” and “alcohol measurement” merely to be representative of all such measurements and the term are not intended to be limiting in any way.

In some embodiments, the alcohol measurement system may be based on diffuse reflectance spectroscopy of the skin or of the nail bed. In some embodiments, the diffuse reflectance alcohol measurement may be made on the top (dorsal) surface of the finger or hand. During the same measurement session, a multispectral sensor may be positioned to collect the biometric information from the bottom (ventral, palmar) surface of the finger or hand. In this way, the identity of the person on whom the diffuse reflectance measurement is being made is closely coupled with the acquisition of identifying features. In other embodiments, the alcohol measurement may be made on the ventral side of the finger or hand, while the biometric measurement may be made on the dorsal side of the finger or hand based on, for example, hand shape or characteristics of the nailbed, or other such measurements. Other configurations that combine diffuse reflectance measurements of alcohol with biometric measurements made on the same body part at nearly the same time are also possible as one knowledgeable in the art would understand. In some cases, both measurements may be processed in such a way that authorization is granted only in cases where two conditions are met: 1) the measured alcohol concentration is at or below a certain level and 2) that the biometric features acquired from the finger or hand are sufficiently similar to such features previously recorded for an authorized user.

### Computational Device

FIG. 26 shows a block diagram of computational unit 2600 that can be used inc conjunction or as part of a biometric sensor system. The figure broadly illustrates how individual system elements may be implemented in a separated or more integrated manner. Moreover, the drawing also illustrates how each of the four imagers 2610 may include a dedicated processor 2615 and/or dedicated memory 2620. Each dedicated memory 2620 may include operational programs, data processing programs, instructions for carrying out methods described herein, and/or image processing programs operable on the dedicated processors 2615. For example, the dedicated memory 2620 may include programs that can be executed by CPU 2602 and/or provide image processing. The computational device is shown comprised of hardware elements that are electrically coupled via bus 2630. The bus 2630, depending on the configuration, may also be coupled with the one or more LED(s) 2605, a proximity sensor (or presence sensor) 2612 and four imaging subsystems 2604 according to various embodiments. In another embodiment, imager memory 2620 may be shared amongst imagers 2615 and/or with the computational device 2602.

In such embodiments, an imaging subsystem may include an imager 2610, a processor 2615, and memory 2620. In other embodiments, an imaging subsystem 2604 may also include light sources and/or optical elements. Imaging subsystems 2604 may be modular and additional imaging subsystems may be easily added to the system Thus, biometric sensor subsystems may include any number of imaging subsystems 2604. The various imaging subsystems, in one embodiment, may be spatially modular in that each imaging subsystem is used to image a different spatial location. The various imaging subsystems, in another embodiment, may be multispectrally modular in that each imaging subsystem is used to image a different multispectral condition. Accordingly, in such an embodiment, an imaging subsystem 2604 may also include various optical elements such as, for example, color filter arrays, color filters, polarizers, etc and/or the imager 2610 may be placed at various angles relative to the imaging location. The various imaging subsystems, in another embodiment, may provide focus modularity in that each imaging subsystem is used to image a different focal point or focal plane.

The hardware elements may include a central processing unit (CPU) 2650, an input/output device(s) 2635, a storage device 2655, a computer-readable storage 2640, a network interface card (NIC) 2645, a processing acceleration unit 2648 such as a DSP or special-purpose processor, and a memory 2660. The computer-readable storage 2640 may include a computer-readable storage medium and a computer readable medium reader, the combination comprehensively representing remote, local, fixed, and/or removable storage devices plus storage media for temporarily and/or more permanently containing computer-readable information. The NIC 2645 may comprise a wired, wireless, modem, and/or other type of interfacing connection and permits data to be exchanged with external devices.

The biometric sensor system 2600 may also comprises software elements, shown as being currently located within working memory 2660, including an operating system 2665 and other programs and/or code 2670, such as a program or programs designed to implement methods described herein. It will be apparent to those skilled in the art that substantial variations may be used in accordance with specific requirements. For example, customized hardware might also be used and/or particular elements might be implemented in hardware, software (including portable software, such as applets), or both. Further, connection to other computing devices such as network input/output devices may be employed.

Computational unit 2600 can be used to carry out processes shown in any of the figures and described in the specification. Specific instructions and/or program code can also be stored in memory 2618 or 2612 and executed by CPU 2602.

### SUMMARY

As described above multispectral system can be used for various applications. Fingerprint sensors are used as one component of an overall solution to provide access to physical spaces or devices (“physical access”) or logical devices and services (“logical access”). In some cases a fingerprint sensor that is used for physical access may be built into a terminal that contains a keyboard, touch pad, touch screen and/or a card reader. The keyboard, touch pad or touch screen may be used by the user to input a PIN, user name, or password in conjunction with or as an alternative to providing a fingerprint image in order to gain access to the equipment, area, room or other entity that is protected by the physical access system. In some embodiments, physical access can include gaining access to the interior of an automobile and/or starting an automobile.

In addition or alternatively, an identification card may be read by an associated card reader to further aid proper identification and authorization of the user prior to granting access. This card reader may read a card that encodes information magnetically or electronically in nonvolatile memory or some other means. The card may further be a contact based card or contactless card that is read through an RF signal or other means. The card may further be a simple static card or a smart card capable of being read, written and/or performing some computations within the card itself.

A physical access system may further comprise a surveillance system. Such surveillance systems may comprise one or more cameras viewing one or more scenes. The images from such cameras may be archived for later retrieval or may be analyzed manually or automatically or through some combination of the two methods. The surveillance images may be analyzed to detect people, baggage, motion and/or visual anomalies in the scene or scenes being viewed.

A fingerprint sensor used for logical access may be incorporated in a personal computer that is one of a variety of configurations including desktop, laptop, rack mount, etc. The computer may act as a server, a cloud computer, a host system or a client system in a networked environment, or it may be a free-standing system in a non-networked system configuration. In any case, the fingerprint sensor may be incorporated with the computer in some fashion. Further, it may be necessary to enter a PIN, user name, or password into the computer in conjunction (before, during or after) acquiring a fingerprint image in order to access the system, network, and/or service(s). Additionally or alternatively, the fingerprint reader may be further combined with a keypad, touch screen, touch pad, and/or a card reader just as in the case of the physical access scenario described above.

In some cases, fingerprint systems are unable to acquire a fingerprint image from a properly authorized user that is suitable for matching to another prerecorded fingerprint. This may be due to the condition of the skin (worn, dry, damaged, wet, dirty), to the unavailability of the previously recorded finger (missing or otherwise unavailable), the presence of muscle tremors, and other such occurrences. In such cases, fingerprint systems require a “work-around” such as allowing the user to use a simple password to gain access. In the cases where the system in attended, such work-around cases may require the intervention of a supervisor, guard or other authorized individual to manually confirm the user's identity, which may increase system cost and/or complexity while reducing applicability and/or security.

A biometric system that incorporates a fingerprint sensor may further comprise other biometric sensors to collect other biometric modalities and combine the biometric information in some way prior to granting access. Such multi-biometric systems may, for example, comprise of a fingerprint sensor and an iris sensor and a facial imaging system. Images from each of the biometric sensors may be analyzed to match against data contained in a database of some kind to produce match values for each of the modalities that may then be combined in some way to determine a final match value.

In many embodiments of the invention biometrics or secondary credentials can be used to gain access to something. Access can be provided for example, to machinery, an automobile, a secure area, computer programs, computer databases, a boat, an airplane, a building, a mobile phone, a mobile computing device, a rental car, etc. Moreover access can include starting a car, starting a machine, initiating preset preferences, starting a process, engaging or releasing a mechanism, performing a function, etc.

1. A system comprising:
an illumination source;
an imaging system; and
a controller interfaced with the illumination source and the imaging system, the controller including:
instructions to illuminate a purported skin site of an individual using the illumination source;
instructions to derive an image of the purported skin site from light received by the imaging system after scattering from the purported skin site;
instructions to illuminate an object different from a skin site using the illumination source; and
instructions to derive an image of the object from light received by the imaging system after scattering from the object.

2. The system according to claim 1, wherein the image of the purported skin site comprises an image of dermatoglyphic patterns of the skin site.

3. The system according to claim 1, wherein the instructions to illuminate the purported skin site further comprises instructions to illuminate the purported skin site under a plurality of distinct optical conditions.

4. The system according to claim 3, wherein the instructions to derive an image of the purported skin site further comprises instructions to derive a multispectral image of the purported skin site from light scattered from the skin site for each of the plurality of distinct optical conditions.

5. The system according to claim 1, wherein the instructions to illuminate the object further comprises instructions to illuminate the object under a plurality of distinct optical conditions.

6. The system according to claim 5, wherein the instructions to derive an image of the object further comprises instructions to derive a multispectral image of the object from light scattered from the skin site for each of the plurality of distinct optical conditions.

7. The system according to claim 1 further comprising instructions to determine whether the object is fraudulent from the image of the object.

8. The system according to claim 1, wherein the object comprises an optical security marking.

9. The system according to claim 8, wherein the optical security marking comprises an optical security marking that is optically variable.

10. The system according to claim 8, wherein the optical security marking comprises a hologram.

11. The system according to claim 8, wherein the optical security marking comprises optically color shifting ink.

12. The system according to claim 1, wherein the object comprises machine readable data.

13. The system according to claim 12, wherein the machine readable data comprises a barcode.

14. The system according to claim 13, wherein the barcode is either a one dimensional barcode or a two dimensional barcode.

15. The system according to claim 12, wherein the machine readable data is imaged from a portable electronics device display.

16. The system according to claim 12, wherein the machine readable data comprise data that is optically variable.

17. The system according to claim 12, wherein the machine readable data comprises either or both of a hologram and a color shifting ink.

18. The system according to claim 17, wherein the hologram is an element of the machine readable data, is part of a substrate upon with the machine readable data is printed, or is part of a laminate covering the machine readable data.

19. The system according to claim 12, wherein the machine readable data comprises data selected from the group consisting of machine readable text and ordinary text.

20. A method comprising:
illuminating a skin site of an individual using an illumination system;
deriving a skin site image of the skin site of an individual from light scattered from the skin site of the individual using an imager;
performing a biometric function with the skin site image;
illuminating machine readable data using the illumination system; and
deriving a data image from light scattered from the machine readable data using the imager.

21. The method according to claim 20, wherein the imaging a skin site of an individual comprises imaging dermatoglyphic features of the skin site.

22. The method according to claim 20, wherein the imaging the skin site provides a multispectral image and the biometric function is performed using the multispectral image.

23. The method according to claim 20, wherein the imaging machine readable data provides images of a security marking.

24. The method according to claim 20 further comprising determining whether the machine readable data is fraudulent.

25. The method according to claim 20 further comprising determining whether the machine readable data is fraudulent by analyzing the multispectral content of the multispectral image.

26. The method according to claim 20 further comprising extracting a message from an image of the machine readable data.

27. A system comprising:
an illumination source;
an imaging system; and
a controller interfaced with the illumination source and the imaging system, the controller including:
instructions to illuminate an object comprising machine readable data under a plurality of distinct optical conditions during a single illumination session; and
instructions to derive a multispectral image of the machine readable data from light received by the imaging system after scattering from the machine readable data for each of multiple of the plurality of distinct optical conditions.

28. The system according to claim 27, wherein the object is an inanimate object.

29. The system according to claim 27 further comprising determining whether the object is fraudulent by analyzing the multispectral image.

30. The system according to claim 29 further comprising determining whether the object is fraudulent by analyzing the multispectral content of the multispectral image.

31. The system according to claim 27, wherein the machine readable data comprises optically variable machine readable data.

32. A method comprising:
illuminating machine readable data under a plurality of distinct optical conditions;
receiving light scattered from the machine readable data separately for each of the plurality of distinct optical conditions; and
determining whether the machine readable data is fraudulent.

33. The method according to claim 32, wherein the machine readable data is affixed with an inanimate object.

34. The method according to claim 32, wherein the determining whether the machine readable data is fraudulent comprises analyzing the multispectral content of images of the machine readable data.

35. The method according to claim 32, wherein the machine readable data comprises a multispectral feature.

36. The method according to claim 36, wherein the machine readable data comprises a data content portion that is separate from the multispectral feature.

37. The method according to claim 36, wherein the machine readable data comprises a data content portion that includes multispectral features.

38. The method according to claim 32, wherein the machine readable data comprises an optically varying feature.

39. The method according to claim 38, wherein the machine readable data comprises a data content portion that is separate from the optically varying feature.

40. The method according to claim 38, wherein the machine readable data comprises a data content portion that includes optically varying feature.

41. The method according to claim 32 further comprising extracting a message from the machine readable data.

42.-159. (canceled)
